(19) United States
(12) Patent Application Publication
(10) Pub. No.: US 2026/0330389 A1
(43) Pub. Date: Oct. 22, 2026

(54) System, Method Executed by System, and Recording Medium Containing Program

(71) Applicant: Hitachi, Ltd., Tokyo (JP)

(72) Inventors: Daisuke ISHII, Tokyo (JP); Kiyotaka TAKAHASHI, Tokyo (JP); Toshiaki SUZUKI, Tokyo (JP)

(21) Appl. No.: 19/467,936

(22) Filed: Feb. 3, 2026

(30) Foreign Application Priority Data
Feb. 19, 2025 (JP) 2025-024740

(51) Int. Cl. G06Q 10/0639

(52) U.S. Cl. CPC G06Q 10/06393

(57) ABSTRACT

A relevant data source identifying unit 1700 identifies a primary data source condition 133 on the basis of performance indicator identification information 132 and performance indicator analysis information 103, identifies primary data source corresponding business process identification information 159 on the basis of the primary data source condition 133 and data source characteristic information 106, determines, for each business process identification information 152, business process relevance value 701 on the basis of the primary data source corresponding business process identification information 159 and business process relevance information 107, determines an importance score 801 for each data source identification information 162 on the basis of the business process relevance value 701 and the data source characteristic information 106, and identifies a relevant data source related to a performance indicator on the basis of the importance score 801.

The present disclosure relates to utilization of information or data used in individual business processes across various different processes.

### BACKGROUND

Organizations and individuals that perform activities engage in various kinds of business. Herein, the “business” generally refers to undertakings that require investment in resources such as people, goods, money, and information. The business may be divided according to each matter that the business addresses. The business may be divided according to the type or phase of activities performed regarding the same matter. An information processing system is often used to enable organizations or individuals to execute these individually divided business processes. The overall processing realized by an information processing system for these individually divided business processes may be referred to as individually divided business processes (business tasks or business jobs).

When individually divided business processes are executed, information or data may be independently collected or generated in each of the business processes. When the business processes are constructed individually (e.g., siloed), making information or data handled by one business process available for handling in another business process is not necessarily self-evident and may rely on tacit knowledge specific to individuals.

Japanese Patent Application Publication No. 2024-30511 is a prior-art document that concerns relationships between business processes. No. 2024-30511 discloses treating each business process as a node, treating each resource related to the business process as a node, and representing relationships between these nodes by a directed graph.

### SUMMARY

As information or data handled by respective business processes (hereinafter referred to as “data sources”) is used across different business processes, analyses and decisions in business operations can be expected to become more appropriate.

However, as already pointed out, business processes are often constructed individually (e.g., siloed), and data sources are often independently collected or generated in respective processes. This may give rise to a situation in which business process information systems having mutually different configurations coexist, and data sources in mutually incompatible formats also coexist. If this is addressed by relying on tacit knowledge specific to individuals, there is a risk that human costs will increase and that temporal costs will also become greater.

In performing analyses or making decisions in business operations, it is assumed that performance indicators (Key Performance Indicators (KPIs)) will also become diversified. For example, in a factory or a power plant, not only performance indicators (KPIs) based on viewpoints such as productivity but also performance indicators (KPIs) based on viewpoints such as environmental impact or sustainability can serve as criteria in performing analyses or making decisions in business operations.

Furthermore, there may be instances where multiple performance indicators (KPIs) are desirably considered at the same time by the same organization or the same individual. Circumstances may change over time, and the performance indicators (KPIs) desired to be considered by the same organization or individual may change.

In this way, a wide variety of performance indicators (KPIs) may be handled in performing analyses or making decisions in business operations. Therefore, a system that predetermines a limited number of fixed performance indicators (KPIs) and handles only those performance indicators (KPIs) may not adequately address the demands in performing analyses or making decisions in business operations.

The data sources handled by respective business processes are not necessarily fixed.

For example, in an information processing system that implements (executes) a business process, when a hardware change (e.g., addition, modification, or deletion of IoT devices within the information processing system), a software change (e.g., a change in a data source format), or a change in specifications or rules occurs, it may be desirable to distinguish between data sources handled before the change and those handled after the change. The number of data sources handled may change between before and after the change. Even without such a change as described above, it may be desirable in some cases to distinguish, within the same type of data source, between earlier data sources and more recent data sources in a time series. Alternatively, it may be desirable in some cases to distinguish, within the same type of data source, between data sources from periods with high update frequency or reference frequency and data sources from periods with low update frequency or reference frequency. Due to these circumstances, the data sources desirable to be handled in performing analyses or making decisions in business operations are not necessarily fixed. Therefore, a system that determines the data sources to be handled for each performance indicator (KPI) in a fixed manner may not always be able to present data sources appropriate as the basis for analyses or decisions in business operations. Furthermore, in view of the circumstances described above, manually identifying (tracking) data sources that could be effectively utilized depending on the performance indicator (KPI) under consideration may result in increased human costs and increased temporal costs.

When respective business processes are constructed individually (e.g., siloed), information indicating whether relationships (relevance) exist between the business processes is not necessarily available in advance. Therefore, the presence or strength of such relationships (relevance) is not always clear. Furthermore, the presence or strength of the relationships (relevance) may change over time due to changes in the specifications of the business processes or in the data sources handled by the processes.

In view of the above circumstances, when respective business processes are constructed individually (for example, siloed), a technology that presupposes the provision of information indicating the presence or absence of relationships (relevance) between business operations (processes) is provided, such as that disclosed in Japanese Patent Application Publication No. 2024-30511, may, depending on the situation, fail to appropriately capture the relationships (relevance) between the business processes. When the relationships (relevance) between the business processes are not appropriately captured, it may not always be possible to appropriately identify, when performing analyses or making decisions in business operations, the data sources corresponding to the performance indicator (KPIs) under consideration. Furthermore, in view of the above circumstances, manually identifying (tracking) the presence or absence and the strength of the relationships (relevance) between the business processes may pose a risk of increased human costs and increased temporal costs.

With the foregoing in view, it may be an object of the present disclosure to accurately realize processing for identifying a data source corresponding to a performance indicator (KPI) received for consideration, from among data sources handled by respective business processes, while suppressing manual intervention.

To achieve at least one of the objects, the present disclosure may provide include, for example, the following features. One aspect of the present disclosure relates to a system. The system has a relevant data source identifying unit. The system has performance indicator analysis information, data source characteristic information, and business process relevance information.

The performance indicator analysis information has, for each performance indicator (KPI), a primary data source condition corresponding to the performance indicator (KPI). The data source characteristic information has, for each data source, business process identification information which is identification information of a business process corresponding to the data source. The business process relevance information has business process relevance for each pair of the business processes.

The relevant data source identifying unit identifies the primary data source condition on the basis of performance indicator identification information which is identification information of a received performance indicator (KPI) and the performance indicator analysis information. The relevant data source identifying unit identifies primary data source corresponding business process identification information on the basis of the identified primary data source condition and the data source characteristic information. The relevant data source identifying unit determines, for each of the business process identification information, business process relevance between the business process identification information and the primary data source corresponding business process identification information on the basis of the identified primary data source corresponding business process identification information and the business process relevance information. The relevant data source identifying unit determines, for each data source identification information which is identification information of a data source, an importance score for the data source for the received performance indicator (KPI) on the basis of the business process relevance determined for each of the business process identification information and the data source characteristic information. The relevant data source identifying unit identifies a relevant data source which is the data source related to the received performance indicator (KPI) on the basis of the importance score determined for each of the data source identification information.

As described above, in the present disclosure, an importance score for the performance indicator (KPI) is determined for each data source in accordance with the received performance indicator identification information. Here, even a data source other than the primary data source indicated by the primary data source condition corresponding to the received performance indicator (KPI) may have a high importance score depending on circumstances such as the business process relevance in which the business process corresponding to the data source is involved. That is, among data sources other than the primary data source indicated by the primary data source condition, a data source having high importance for the received performance indicator (KPI) can be identified. In this manner, even in situations in which each business process handles its own data source and manual capture of such relationships is not easy, data sources of high importance that even a person requesting examination of the performance indicator (KPI) may fail to notice can be identified.

Furthermore, as described above, according to the present disclosure, various pieces of information including primary data source conditions corresponding to the performance indicator (KPI), characteristics of data sources containing the corresponding business process identification information, and business process relevance within each business process pair are managed on the basis of the performance-indicator analysis information, the data source characteristic information, and the business process-relevance information. Accordingly, even when any of these kinds of information undergoes some change, such changes can be handled flexibly and appropriately in the present disclosure.

In view of the above, according to the present disclosure, a data source corresponding to the received target performance indicator (KPI) can be accurately identified from among the respective data sources handled by the respective business processes while suppressing manual intervention.

A method or a program that realizes processing the same as the system described above can also achieve the same advantageous effect as the system described above. In a program-based implementation costs are often reduced, and design changes to the processing are facilitated.

Other features that may be provided by the present disclosure, and the corresponding advantageous effects of such features are disclosed in the specification, the claims, or the drawings.

### BRIEF DESCRIPTION OF THE DRAWINGS

FIG. 1 shows a functional configuration related to identification of relevant data sources for performance indicators (KPIs);

FIG. 2 shows an overall system configuration including a system of an embodiment of the present disclosure;

FIG. 3 shows a KPI analysis table (performance indicator analysis information);

FIG. 4 shows a primary data source condition version management table;

FIG. 5 shows a business process list table;

FIG. 6 shows a data source characteristics table;

FIG. 7 shows a business process relevance table;

FIG. 8 shows an importance score table;

FIG. 9 shows a data access log table;

FIG. 10 shows a form input type data source identification GUI;

FIG. 11 shows a chat type data source identification GUI;

FIG. 12 shows a KPI analysis table setting GUI (performance indicator analysis information setting GUI);

FIG. 13 shows a business process registration GUI;

FIG. 14 shows a data source-business process relationship registration GUI;

FIG. 15 shows processing performed by a relevant data source identification overall control unit;

FIG. 16 shows processing performed by a KPI name receiving unit (performance indicator identification information receiving unit);

FIG. 17 shows processing performed by a relevant data source identifying unit;

FIG. 18 shows processing performed by a relevant data source related information display control unit;

FIG. 19 shows processing performed by a primary data source condition updating unit;

FIG. 20 shows processing performed by an access history collection unit;

FIG. 21 shows processing performed by a business process relevance updating unit;

FIG. 22 shows processing performed by a KPI analysis table setting receiving unit;

FIG. 23 shows processing performed by a business process registration receiving unit;

FIG. 24 shows processing performed by a data source-business process relationship registration receiving unit; and

FIG. 25 shows a computer architecture.

### DETAILED DESCRIPTION OF THE EMBODIMENT

Embodiments of the present disclosure will now be described in detail with reference to the accompanying drawings. The embodiments which will be described below are not intended to limit the disclosure according to the scope of the claims. Furthermore, not all elements and combinations thereof described in the embodiments are necessarily essential to the solutions provided by the present disclosure.

Each system, apparatus, or functional unit of the present disclosure may be implemented as a single hardware unit or may be divided into multiple parts that cooperate with one another to perform their functions. A plurality of systems, apparatuses, or functional units may be integrated into hardware.

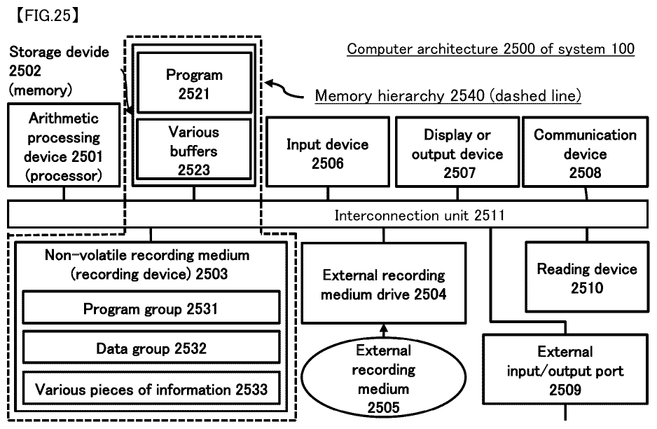

The system, the apparatus, and the functional unit may each be implemented by causing a computer to execute software (a program) (as shown in FIG. 25). Some of the functions of the system, the apparatus, or the functional unit may be implemented by hardware (e.g., hardwired logic or a field-programmable gate array (FPGA)), and the remaining functions may be implemented by executing software (a program). All of the functions of any one of the system, apparatus, and functional unit may be implemented in hardware.

One or more hardware resources may implement one or more of the system, apparatus, and functional unit of the present disclosure. For this purpose, each of the system, apparatus, or functional unit of the present disclosure may be implemented virtually. For example, virtual machine or virtual container techniques may be used.

The program is not limited to any specific type or form. The program may also be initially recorded in a compressed format. A system, an apparatus, a functional unit, or some of the functions of the functional unit need not be realized continuously when they are implemented by causing a computer to execute software (the program). That is, it is sufficient that the system, apparatus, functional unit, or some of the functions of the functional unit are realized at the timing when the processing provided thereby is required.

Elements designated by the same reference numbers in multiple drawings are substantially identical. In the flowchart drawings, rectangular boxes indicate processing steps, while hexagonal boxes indicate conditional branching steps. In the flowchart drawings, “step” is abbreviated as “S”. In the drawings, numbers enclosed in circles indicate that the portions designated by the same numbers are connected for control purposes. In the drawings, letters enclosed in parentheses indicate that the portions designated by the same letters are connected for control purposes. In the drawings, solid-line rectangles whose names include the suffix “unit” indicate functional units. Displays and the like shown in the drawings are merely examples, and other forms of display may also be used.

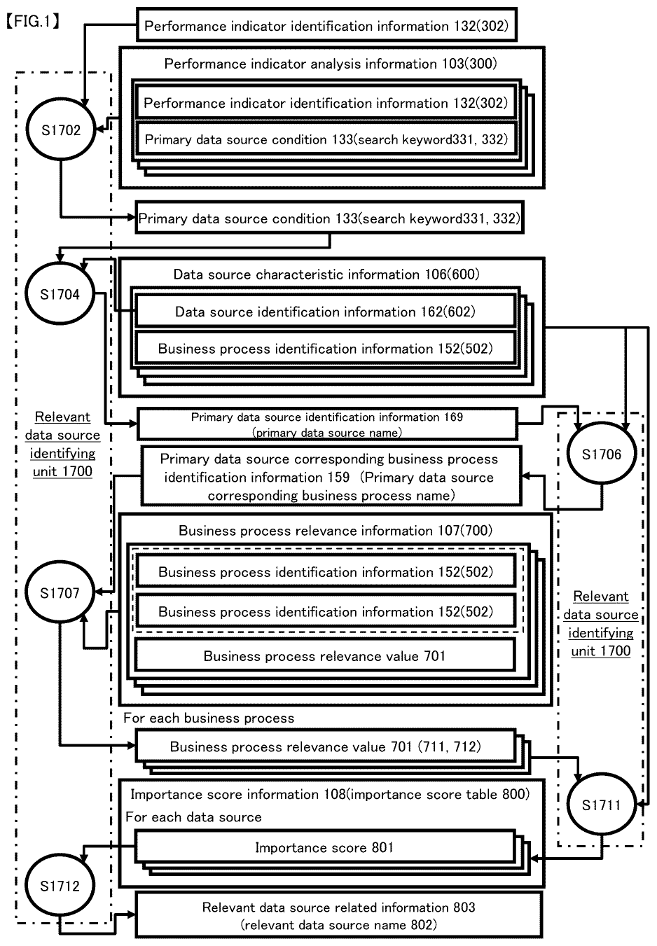

### 1. Outline of Functional Configuration Related to Identification of Relevant Data Sources for Performance Indicator (KPI) (FIG. 1)

This section outlines the functional configuration related to identifying relevant data sources for a performance indicator (KPI) among the functional configurations of the embodiment of the present disclosure. Details of the functional configurations will be described later in Section 4, “Functional Configuration, Processing, and Information of the Embodiment.”

FIG. 1 shows an outline of the functional configuration (and information handled) of a system 100 of the embodiment of the present disclosure, which relates to identifying relevant data sources for a performance indicator (KPI). Note that not all functional configurations shown in FIG. 1 are essential. Functional configurations other than those shown in FIG. 1 are not precluded.

The system 100 may be implemented on a computer architecture 2500 as will be described later in Section 3, entitled “Computer Architecture for Implementing the Embodiment of the Disclosure” (and FIG. 25). The system 100 may include an arithmetic processing device 2501 (one or more processors) and a memory hierarchy 2540 as shown in FIG. 25.

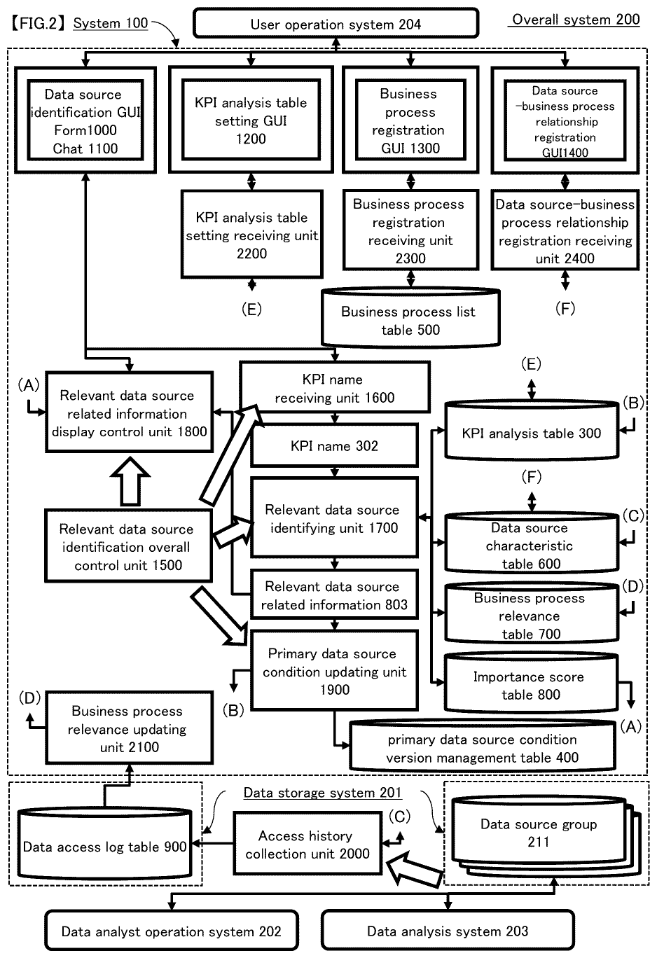

The memory hierarchy 2540 may have (store or record) an information group (e.g., various tables) shown in FIG. 1 (or FIG. 2). Among the functional units shown in FIG. 1 (or FIG. 2), for those that are implemented by the system 100 executing a program, the program for the functional unit may be stored or recorded in the memory hierarchy 2540.

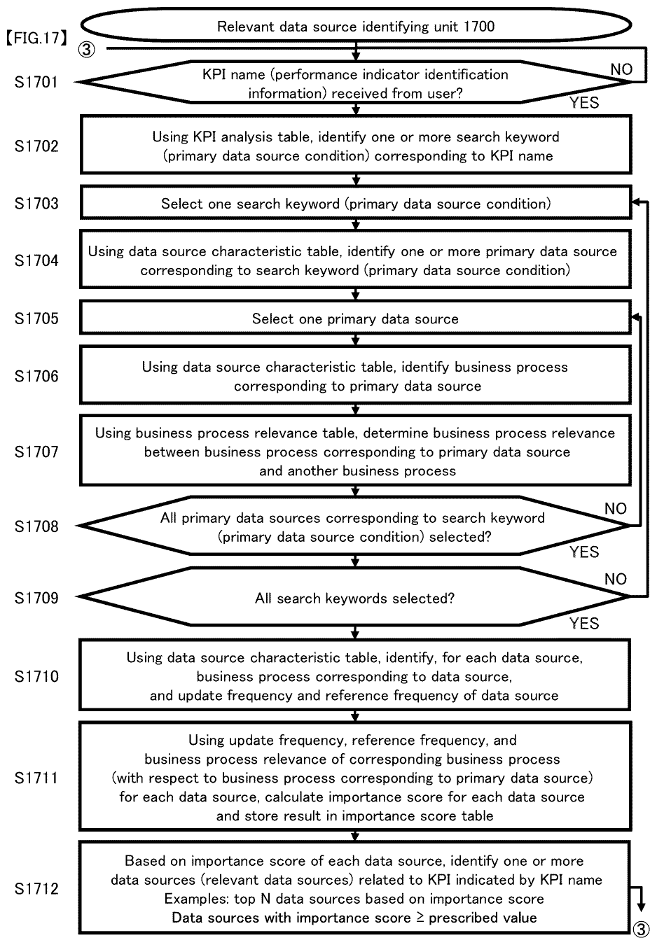

As shown in FIG. 1, the system 100 according to the embodiment of the present disclosure includes a relevant data source identifying unit 1700, which is a functional unit represented by a dash-dot line in FIG. 1. The relevant data source identifying unit 1700 performs the processing shown in FIG. 17 which will be described later. FIG. 1 shows six circles, each containing a step number (starting with S17) in FIG. 17. These numbered circles indicate the processing corresponding to the step numbers in FIG. 17.

As shown in FIG. 1, the system 100 has performance indicator analysis information 103, data source characteristic information 106, and business process relevance information 107. The system 100 may also have importance score information 108. The performance indicator analysis information 103 may be, for example, a KPI analysis table 300 in the drawings from FIG. 2 onward. The data source characteristic information 106 may be a data source characteristic table 600 in the drawings from FIG. 2 onward. The business process relevance information 107 may be a business process relevance table 700 in the drawings from FIG. 2 onward. The importance score information 108 may be an importance score table 800 in the drawings from FIG. 2 onward.

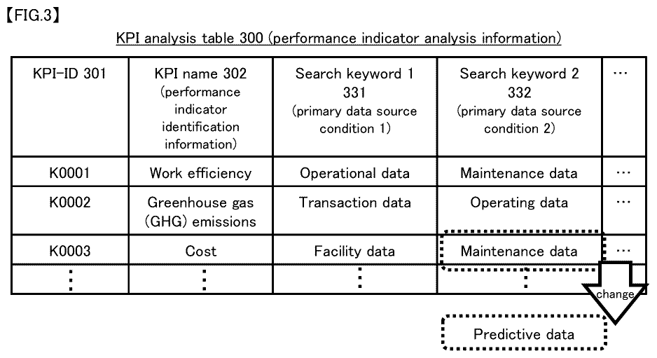

As shown in FIGS. 1 and 3, the performance indicator analysis information 103 (KPI analysis table 300) may have a group of records indicating an association between performance indicator identification information 132 and a primary data source condition 133. The performance indicator identification information 132 may be a KPI name 302 in the drawings from FIG. 2 onward. The primary data source condition 133 may be, for example, a search keyword 331 (or 332) in the drawings from FIG. 2 onward.

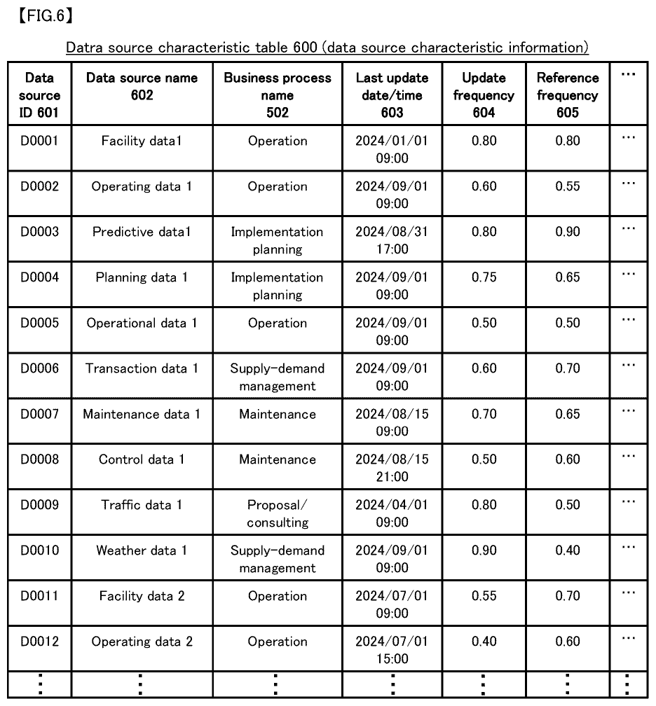

As shown in FIGS. 1 and 6, the data source characteristic information 106 (data source characteristic table 600) may include a group of records indicating associations between data source identification information 162 and business process identification information 152. The data source identification information 162 may be, for example, a data source name 602 in the drawings from FIG. 2 onward. The business process identification information 152 may be for example a business process name 502 in the drawings from FIG. 2 onward.

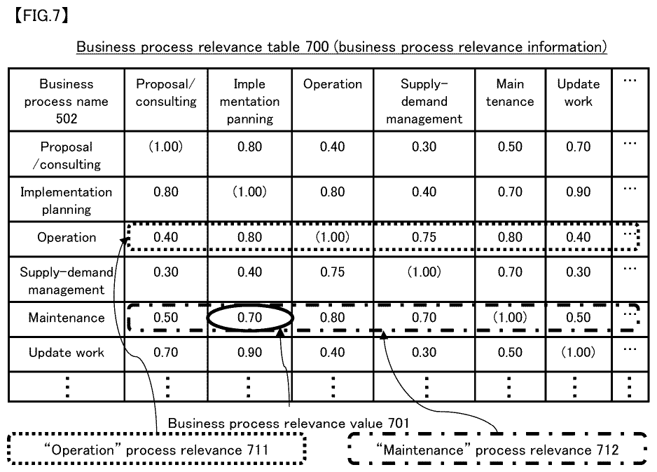

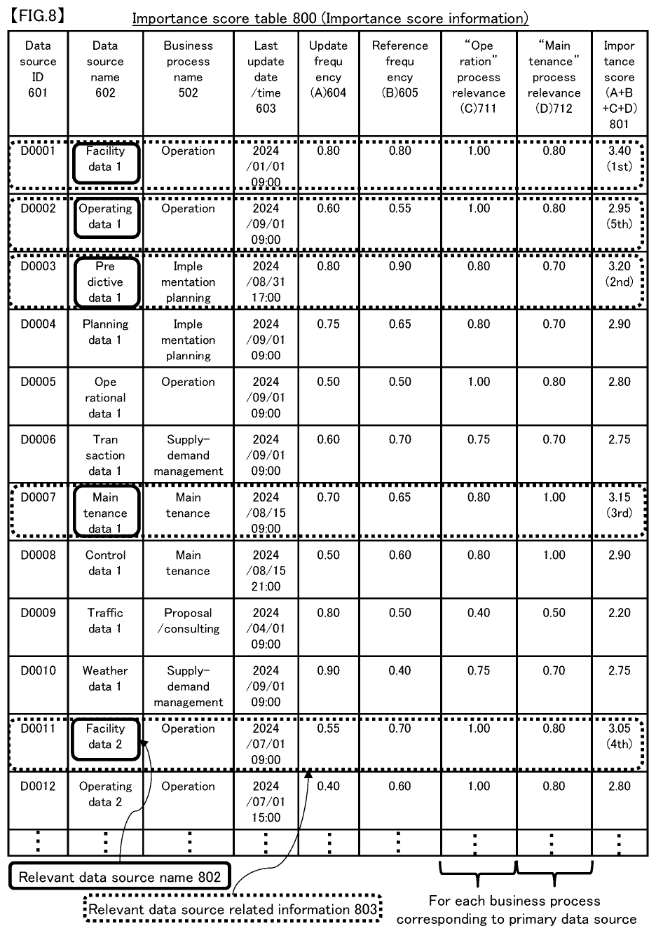

As shown in FIGS. 1 and 7, the business process relevance information 107 (business process relevance table 700) may include a group of records indicating business process relevance value 701 for each pair of business process identification information 152 (business process name 502). As shown in FIGS. 1 and 8, the importance score information 108 (importance score table 800) may include a group of records indicating an importance score 801 for each data source.

As shown at the uppermost part of FIG. 1, the system 100 receives performance indicator identification information 132 (KPI name 302). As shown in FIG. 2, performance indicator identification information 132 (KPI name 302) may be received from the user operation system 204. The user operation system 204 may be, for example, a system including a device operated by a user.

As indicated by the circled S1702 in FIG. 1 and S1702 in FIG. 17, the relevant data source identifying unit 1700 in the system 100 identifies the primary data source condition 133 (search keyword 331 (or 332)) on the basis of the received performance indicator identification information 132 (KPI name 302) and performance indicator analysis information 103 (KPI analysis table 300).

As indicated by the circled S1704 in FIG. 1 and S1704 in FIG. 17, the relevant data source identifying unit 1700 in the system 100 identifies the primary data source identification information 169, which is the identification information for the primary data source, on the basis of the identified primary data source condition 133 (search keyword 331 (or 332)) and the data source characteristic information 106 (data source characteristic table 600). The primary data source identification information 169 may be, for example, the primary data source name for the primary data source among the data source identification information 162 (data source names 602). As will be described in detail later, among the data source identification information 162 (data source name 602) included in the records of the data source characteristic information 106 (data source characteristic table 600), the one matching the primary data source condition 133 (search keyword 331 (or 332)) is identified as the primary data source identification information 169 (primary data source name). As indicated by the circled S1706 in FIG. 1 and S1706 in FIG. 17, the relevant data source identifying unit 1700 in the system 100 identifies primary data source corresponding business process identification information 159 which is the identification information for the business process corresponding to the primary data source, on the basis of the identified primary data source identification information 169 and the data source characteristic information 106 (data source characteristic table 600). The primary data source corresponding business process identification information 159 is the one that corresponds to the primary data source among the business process identification information 152 (business process names 502).

Note that steps S1704 and S1706 may be combined into a single process. That is, the primary data source corresponding business process identification information 159 (primary data source name) may be identified on the basis of the primary data source condition 133 (search keyword 331 (or 332)) and the data source characteristic information 106 (data source characteristic table 600), without extracting the primary data source identification information 169 (primary data source name) which is the intermediate information.

As indicated by the circled S1707 in FIG. 1 and S1707 in FIG. 17, the relevant data source identifying unit 1700 in the system 100 determines a business process relevance value 701 for each business process identification information 152 (business process name 502) on the basis of the identified primary data source corresponding business process identification information 159 (business process name corresponding to the primary data source) and business process relevance information 107 (business process relevance table 700). Here, for each business process identification information 152 (business process name 502), the business process relevance value 701 between the business process identification information 152 (business process name 502) and the primary data source corresponding business process identification information 159 (business process name corresponding to the primary data source) is determined. As will be described later in conjunction with 711 and 712 in FIG. 7, for each business process (identification information thereof) captured (managed) by the business process relevance information 107 (business process relevance table 700), the business process relevance between itself and the business process (identification information thereof) corresponding to the primary data source is determined.

As indicated by the circled S1711 in FIG. 1 and S1711 in FIG. 17, the relevant data source identifying unit 1700 in the system 100 determines an importance score 801 for each item of data source identification information 162 (data source name 602) on the basis of the business process relevance value 701 determined for each item of business process identification information 152 (business process name 502) and on the basis of the data source characteristic information 106 (data source characteristic table 600). Here, the importance score 801 indicates the importance of the data source represented by the data source identification information 162 (data source name 602) for the received performance indicator (KPI) (performance indicator identification information 132 (KPI name 302)). As will be described later in detail, a business process relevance value 701 is determined for each business process identification information 152 (business process name), and the data source characteristic information 106 (data source characteristic table 600) establishes the associations between the data source identification information 162 (data source name 602) and the business process identification information 152 (business process name 502), so that the business process relevance value 701 can be associated with each data source identification information 162 (data source name 602). Furthermore, as shown in FIG. 6, for example, the data source characteristic information 106 (data source characteristic table 600) may also hold information related to other characteristics corresponding to the data source identification information 162 (data source name), in addition to the business process identification information 152 (business process name 502). Therefore, the relevant data source identifying unit 1700 in the system 100 can determine the importance score 801 for each data source identification information 162 (data source name) by appropriately utilizing the business process relevance value 701 and other characteristic related information corresponding to the data source identification information 162 (data source name). Note that FIGS. 1 and 8 show the importance score 801 determined for each data source identification information 162 (data source name 602) being stored in the importance score information 108 (importance score table 800), but the importance score 801 determined for each data source identification information 162 (data source name 602) may be held in a different manner.

As indicated by the circled S1712 in FIG. 1 and S1712 in FIG. 17, the relevant data source identifying unit 1700 in the system 100 identifies a data source related to the received performance indicator (KPI) (performance indicator identification information 132 (KPI name 302)) on the basis of the importance scores 801 determined for each data source identification information 162 (data source name 602). The data source identified in this manner may be referred to as a relevant data source. The identification information of the relevant data source may be the relevant data source name 802 in the drawings from FIG. 2 onward. Various information related to the relevant data source, which will be described later with reference to FIG. 8 and others, may be referred to as relevant data source-related information 803.

As shown in FIG. 2, the relevant data source related information 803 including the relevant data source name 802 is presented to the user operation system 204. A user operating the user operation system 204, to which the relevant data source related information 803 is presented, may request the system 100, via the user operation system 204, to access, as appropriate, one or more relevant data sources for a performance indicator (KPI) under consideration among the data source group 211 shown in FIG. 2, using information included in the relevant data source related information 803, in order to compute or otherwise process the performance indicator (KPI).

As described above, the primary data source indicated by the primary data source identification information 169 (primary data source name) is determined in accordance with the primary data source condition 133 (search keyword 331 (or 332)) that is set corresponding to the performance indicator identification information 132 (KPI name). In contrast, the identification of a relevant data sources related to the performance indicator (KPI) reflects not only the primary data source condition 133 (search keyword 331 (or 332)) but also the characteristics of each data source indicated by the data source characteristic information 106 (data source characteristic table 600) and the relationships among business processes indicated by the business process relevance information 107 (business process relevance table 700). Accordingly, even relevant data sources that the user may easily fail to notice can be presented to the user operating the user operation system 204 by the system 100 according to one embodiment of the present disclosure.

The information held in the data source characteristic information 106 (data source characteristic table 600) and the business process relevance information 107 (business process relevance table 700) may be updated as appropriate according to changes in the circumstances around the data source group 211 (and the business processes executed using the data source group 211) shown in FIG. 2. In addition, the primary data source condition 133 (search keyword 331 (or 332)) may also be updated as appropriate on the basis of the result of determining (calculating) the importance scores 801 for each data source identification information 162. Therefore, the system 100 according to one embodiment of the present disclosure can identify as appropriate relevant data sources corresponding to the performance indicator (KPI) in accordance with such changes in the circumstances.

Since the system 100 of the embodiment of the present disclosure has the above functional configuration, it can exhibit the advantageous effects described in paragraphs [0011] to [0014].

### 2. Overall Configuration Including System 100 and Functional Configuration (FIG. 2)

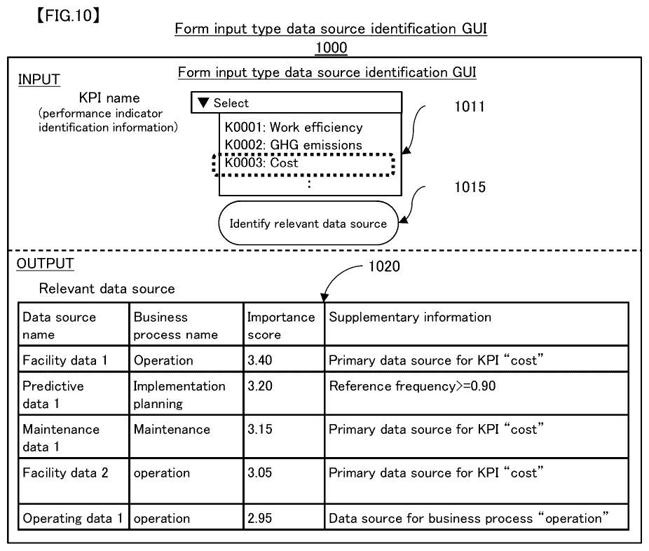

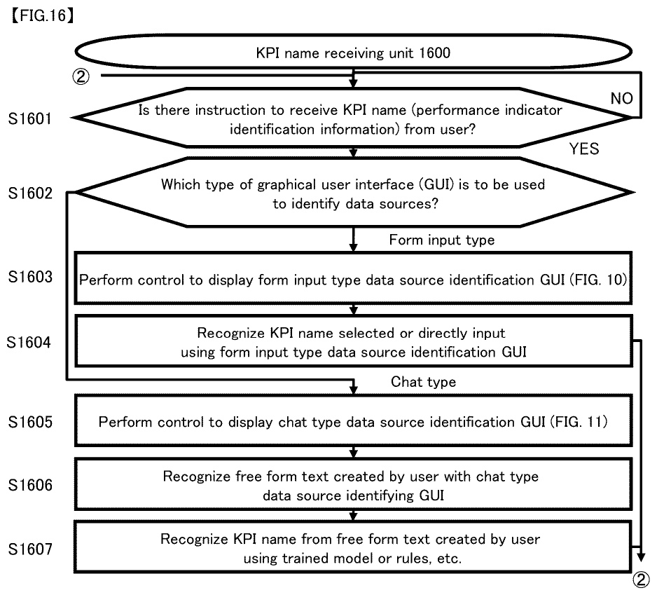

FIG. 2 shows an overall system 200 including the system 100 according to the embodiment of the present disclosure. Note that not all components shown in FIG. 2 are essential, and components other than those shown in FIG. 2 are not precluded. In the following, the components included in the overall system 200 shown in FIG. 2 are described. The following also outlines the flowcharts of processing by various functional units shown in FIGS. 16 to 24, various tables (information) shown in FIGS. 3 to 9, and graphical user interfaces (GUIs) shown in FIGS. 10 to 14. Details of the functional configuration, processing, and information handled by the system 100 according to the embodiment of the present disclosure will be described later in Section 4, entitled “Functional Configuration, Processing, and Information of the Embodiment.”

The computer architecture for implementing the system 100 may be the one described in Section 3, entitled “Computer Architecture for Implementing the Embodiment of the Disclosure,” but other architectures may also be used. The system 100 may include one or more computers (or apparatuses). In this way, various flexible design choices are possible when constructing the system 100.

The data source group 211 shown in FIG. 2 includes the respective data sources handled by the business processes. Each data source may be, for example, a file indicated by the data source name 602 in each record of the data source characteristic table 600 (data source characteristic information) in FIG. 6. As shown in FIG. 2, the data source group 211 may be held in a data storage system 201 (for example, as files stored on a recording medium), which is a system different from the system 100 of the embodiment of the present disclosure. Alternatively, the data source group 211 may be directly handled by the system 100 according to one embodiment of the disclosure.

For example, a data analyst operation system 202 including a device operated by a data analyst, or a data analysis system 203, shown at the lowermost portion of FIG. 2, may implement (execute) the respective business processes and access the data source group 211. The data analysis system 203 may access the data source group 211 in a manner involving relatively less manual intervention compared with the data analyst operation system 202.

As shown at the uppermost portion of FIG. 2, the system 100 according to one embodiment of the present disclosure is configured to communicate interactively with the user operation system 204 operated by a user. The user is a person who wishes to identify relevant data sources related to the performance indicator (KPI) for consideration.

As shown in FIG. 2, the system 100 may implement, in whole or in part, as functional units, the KPI name receiving unit 1600 (performance indicator identification information receiving unit), the relevant data source identifying unit 1700, a relevant data source related information display control unit 1800, a primary data source condition updating unit 1900, a business process relevance updating unit 2100, a KPI analysis table setting receiving unit 2200 (performance indicator analysis information setting receiving unit), a business process registration receiving unit 2300, and a data source-business process relationship registration receiving unit 2400.

The data storage system 201 may include an access history collection unit 2000 as a functional unit. Alternatively, the access history collection unit 2000 may be implemented by the system 100.

Among the functional units, those implemented by executing programs by the system 100 (e.g., one or more processors) need only be implemented when the functions they provide are required. Some or all of the functional units shown in FIG. 2 may be implemented more hardware-wise.

The system 100 may handle some or all of the KPI analysis table 300 (performance indicator analysis information), a primary data source condition version management table 400 (primary data source condition version management information), a business process list table 500 (business process list information), the data source characteristic table 600 (data source characteristic information), the business process relevance table 700 (business process relevance information), and the importance score table 800 (importance score information).

The data storage system 201 may handle a data access log table 900 (data access log information). Alternatively, the system 100 may handle the data access log table 900.

When handled in the system 100, these pieces of information (tables) may be stored or recorded in the memory hierarchy 2540.

The system 100 may present to the user operation system 204 one or more of the following: a form input type data source identification graphical user interface 1000 (form input type data source identification GUI), a chat type data source identification graphical user interface 1100 (chat type data source identification GUI), a KPI analysis table setting graphical user interface 1200 (performance indicator analysis information setting GUI), a business process registration graphical user interface 1300 (business process registration GUI), and a data source-business process relationship registration graphical user interface 1400 (data source-business process relationship registration GUI).

### 2.1. Outline of Functional Units Included in System According to the Embodiment of the Disclosure

The following outlines the functional units that the system 100 (or the data storage system 201) may include. Details of the functions implemented by these functional units will be described later in Section 4. “Functional Configuration, Processing, and Information of the Embodiment.”

### 2.1.1. KPI Name Receiving Unit (Performance Indicator Identification Information Receiving Unit) (FIG. 16)

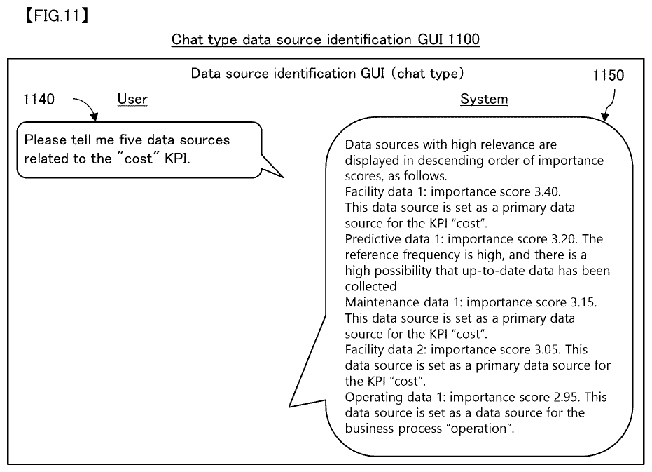

The KPI name receiving unit 1600 receives, via the data source identification graphical user interface (data source identification GUI), the KPI name 302 (performance indicator identification information) from the user operation system 204. Details of the processing performed by the KPI name receiving unit 1600 will be described later with reference to FIG. 16. Note that the data source identification graphical user interface may include the form input type data source identification graphical user interface 1000 (FIG. 10) and the chat type data source identification graphical user interface 1100 (FIG. 11).

### 2.1.2. Relevant Data Source Identifying Unit (FIG. 17)

The relevant data source identifying unit 1700 identifies, from among the data sources included in the data source group 211, a relevant data source that is a data source related to the KPI (performance indicator) indicated by the KPI name 302 received by the KPI name receiving unit 1600, in accordance with the KPI name 302. The relevant data source identifying unit 1700 also identifies relevant data source related information 803, which is various pieces of information concerning the relevant data source. An outline of the processing performed by the relevant data source identifying unit 1700 has already been described in “1. Outline of Functional Configuration related to Identification of Relevant Data Sources for Performance Indicator (KPI).” Additional details and supplementary matters about the processing by the relevant data source identifying unit 1700 will be described later with reference to FIG. 17.

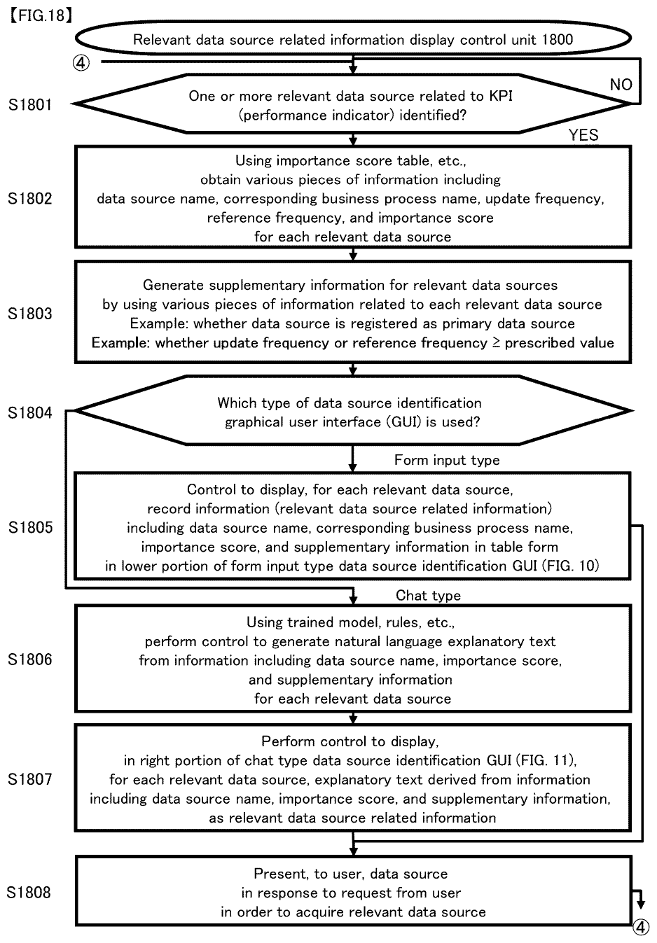

### 2.1.3. Relevant Data Source Related Information Display Control Unit (FIG. 18)

The relevant data source related information display control unit 1800 presents the relevant data source related information 803 to the user operation system 204 via the data source identification graphical user interface. The relevant data source related information display control unit 1800 may also perform processing to respond to access requests from the user operation system 204 to the relevant data sources themselves. Details of the processing performed by the relevant data source related information display control unit 1800 will be described later with reference to FIG. 18.

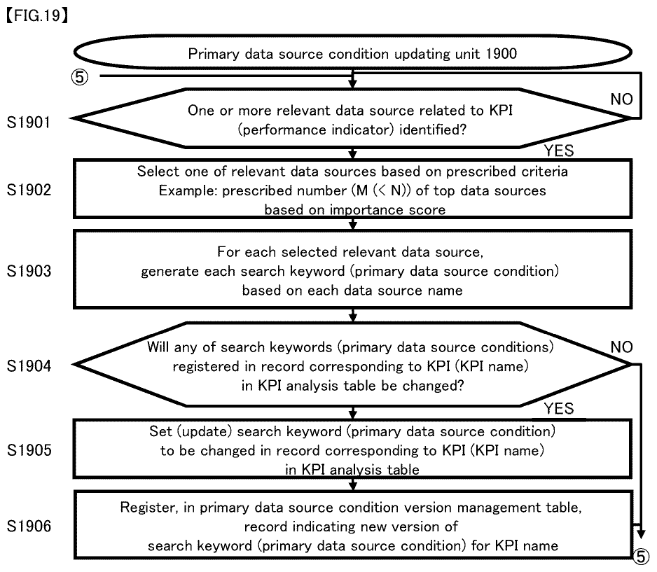

### 2.1.4. Primary Data Source Condition Updating Unit (FIG. 19)

The primary data source condition updating unit 1900 sets (updates) the search keyword 331 (or 332) (primary data source condition) (see FIG. 3) corresponding to any of the performance indicators (KPIs) in the KPI analysis table 300 (performance indicator analysis information), according to the importance score 801 (see FIG. 8) for each data source determined by the relevant data source identifying unit 1700. The primary data source condition updating unit 1900 also registers, in the primary data source condition version management table 400, a new record indicating the setting (update) history each time the search keyword 331 (or 332) corresponding to any of the performance indicators (KPIs) is set (updated).

Details of the processing performed by the primary data source condition updating unit 1900 will be described later with reference to FIG. 19.

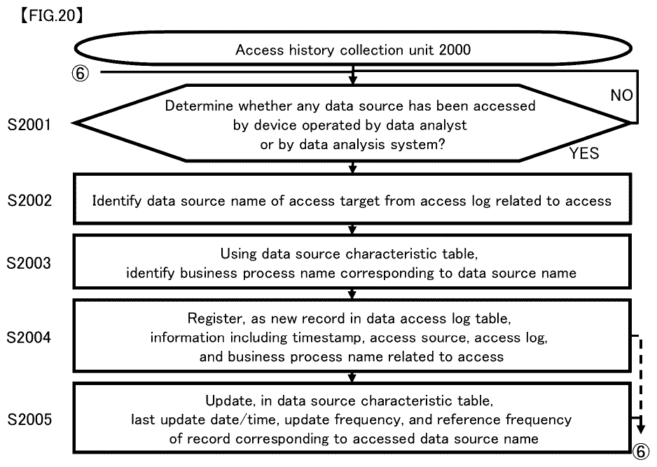

### 2.1.5. Access History Collection Unit (FIG. 20)

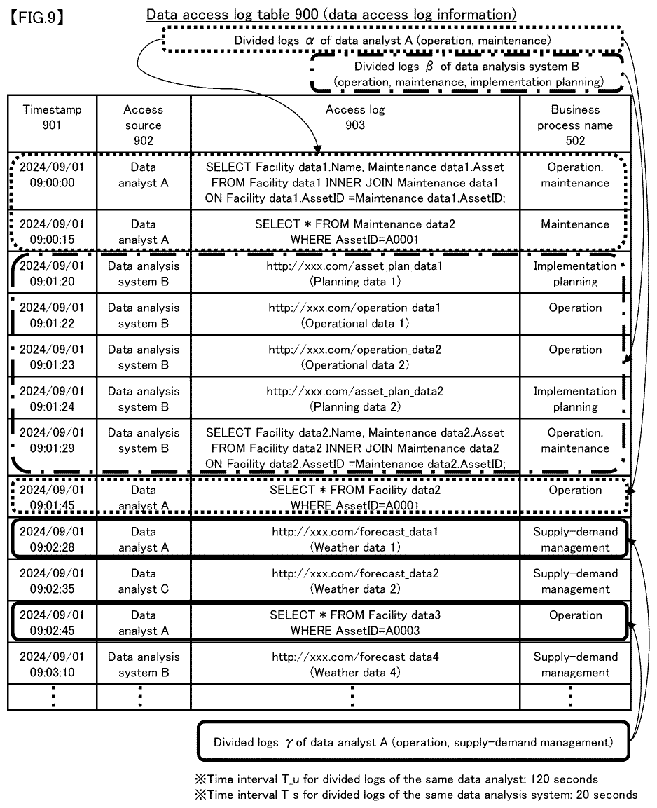

When the data analyst operation system 202 or the data analysis system 203, which serves as an access source 902 (see FIG. 9), implements (executes) any business process and accesses any of the data sources included in the data source group 211, the access history collection unit 2000 collects the access history. The access history collection unit 2000 may store the access history, or information obtained by processing the access history, in the data access log table 900 (data access log information) or in the data source characteristic table 600 (data source characteristic information). Details of the processing performed by the access history collection unit 2000 will be described later with reference to FIG. 20.

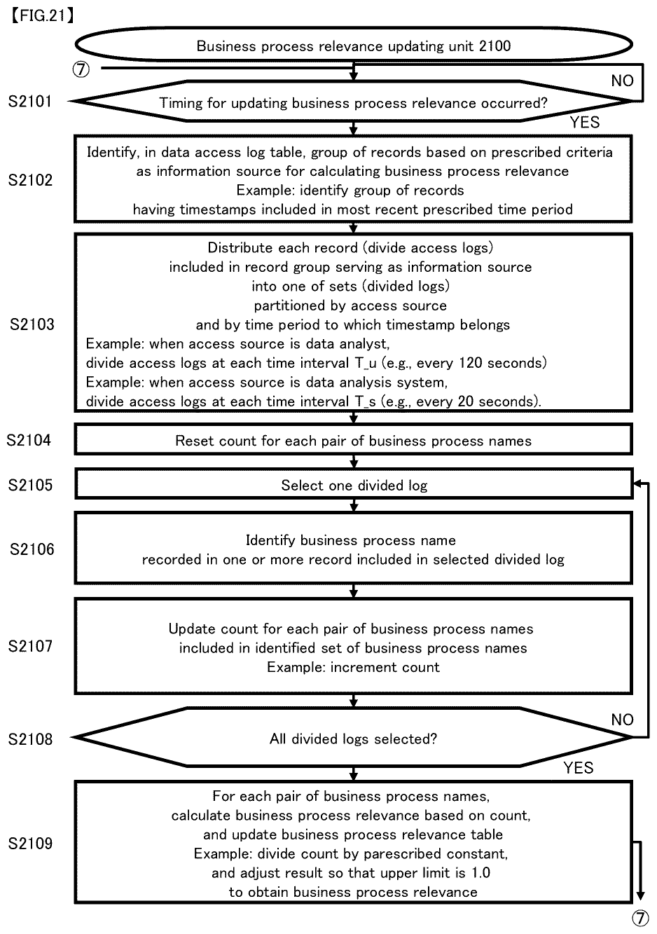

### 2.1.6. Business Process Relevance Updating Unit (FIG. 21)

The business process relevance updating unit 2100 uses information stored in the data access log table 900 to determine (calculate) business process relevance value 701 (see FIG. 7) for pairs of business processes, and stores the determined (calculated) business process relevance value 701 in the business process relevance table 700. Details of the processing by the business process relevance updating unit 2100 will be described later with reference to FIG. 21.

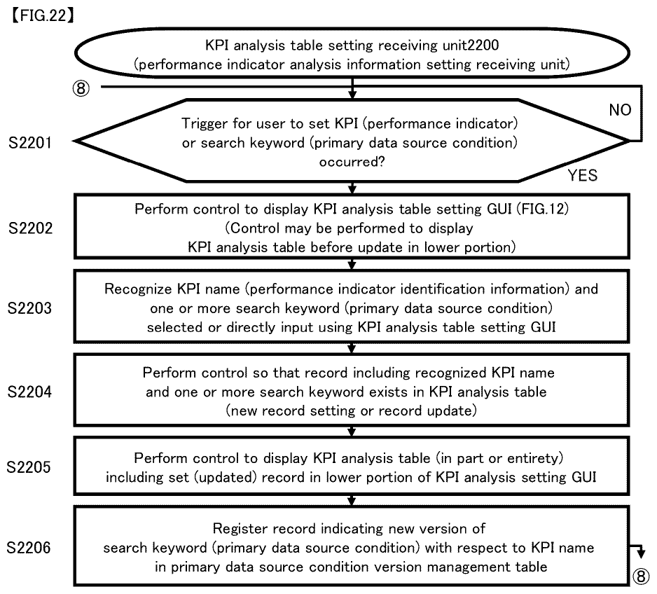

### 2.1.7. KPI Analysis Table Setting Receiving Unit (Performance Indicator Analysis Information Setting Receiving Unit) (FIG. 22)

The KPI analysis table setting receiving unit 2200 receives the KPI name 302 and one or more search keywords 331 (or 332) (see FIG. 3) from the user operation system 204 via the KPI analysis table setting graphical user interface 1200 (performance indicator analysis information setting GUI). The KPI analysis table setting receiving unit 2200 sets a record such that the record including the received KPI name 302 and one or more search keywords 331 (or 332) exists in the KPI analysis table 300. Details of the processing by the KPI analysis table setting receiving unit 2200 will be described later with reference to FIG. 22.

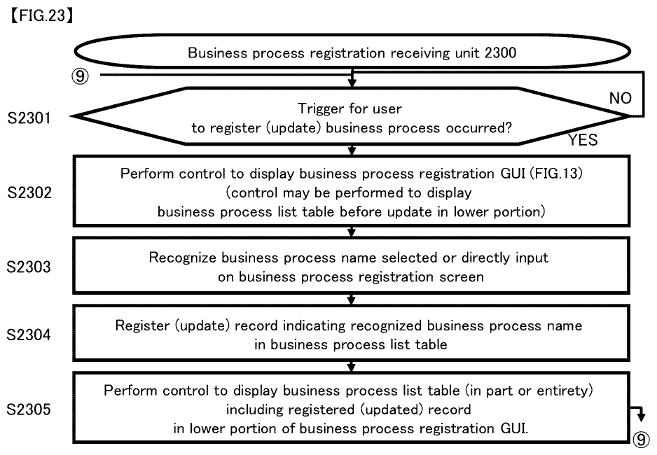

### 2.1.8. Business Process Registration Receiving Unit (FIG. 23)

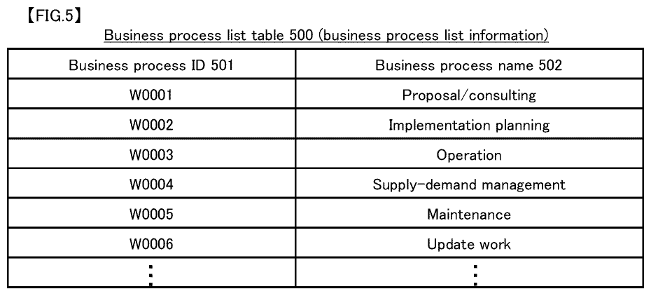

The business process registration receiving unit 2300 receives a business process name 502 (business process identification information) (see FIG. 5) from the user operation system 204 via the business process registration graphical user interface 1300 (business process registration GUI). The business process registration receiving unit 2300 registers, in the business process list table 500 (business process list information), a record including the received business process name 502. Details of the processing by the business process registration receiving unit 2300 will be described later with reference to FIG. 23.

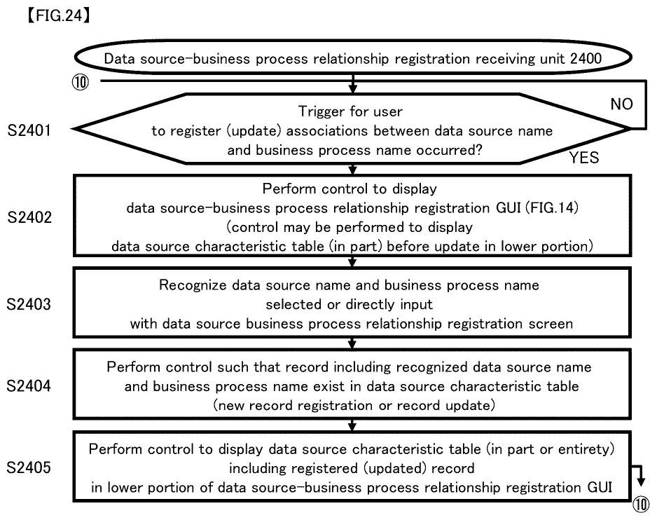

### 2.1.9. Data Source-Business Process Relationship Registration Receiving Unit (FIG. 24)

The data source-business process relationship registration receiving unit 2400 receives a data source name 602 (data source identification information) (see FIG. 6) and a business process name 502 (see FIG. 5) from the user operation system 204 via the data source-business process relationship registration graphical user interface 1400 (data source-business process relationship registration GUI). The data source-business process relationship registration receiving unit 2400 sets the data source characteristic table 600 so that the data source characteristic table includes a record including the received data source name 602 and the business process name 502. Details of the processing by the data source-business process relationship registration receiving unit 2400 will be described later with reference to FIG. 24.

### 2.2. Outline of Information (Tables) Held by Systems According to the Embodiment of the Disclosure

The following outlines the information (tables) that the system 100 (or the data storage system 201) can handle.

### 2.2.1. KPI Analysis Table (Performance Indicator Analysis Information) (FIG. 3)

FIG. 3 shows the KPI analysis table 300.

The KPI analysis table 300 holds clues for identifying the primary data source on which a performance indicator (KPI) indicated by the KPI name 302 (performance indicator identification information) is based when the performance indicator (KPI) is calculated or estimated.

Each record of the KPI analysis table 300 may include a KPI-ID 301, a KPI name 302, and one or more search keywords (primary data source conditions). As shown in FIG. 3, when there are two or more search keyword fields for each record, the fields may be designated as a search keyword 1 (primary data source condition 1), a search keyword 2 (primary data source condition 2), and so on. Note that the number of search keywords for each record is arbitrary.

The KPI-ID 301 is an identification code number assigned to the record of the KPI analysis table 300 and to the KPI name 302. In the example of FIG. 3, the KPI-ID 301 consists of the letter “K” followed by four digits.

The KPI name 302 is information for identifying a performance indicator (KPI). In the example of FIG. 3, the KPI name 302 is a human-readable performance indicator name. Examples of the KPI name 302 shown in FIG. 3 include “work efficiency,” “greenhouse gas (GHG) emissions,” and “cost,” but other KPI names may also be used. Any performance indicator may be used as the KPI name 302 as long as the performance indicator is one that an organization or individual wishes to consider in performing business operations and can be calculated or estimated on the basis of the data source group 221.

The search keywords (search keyword 1 (primary data source condition 1), search keyword 2 (primary data source condition 2), . . . ) indicate, at the time point, the assumed conditions for the primary data source name 602 that is the primary data source for the corresponding KPI name 302. In the example of FIG. 3, when calculating or estimating the performance indicator (KPI) whose KPI name 302 is “cost,” the primary data source condition at the time point is set such that the data source name 602 includes the term “facility data” or the data source name 602 includes the term “maintenance data.”

As already described with reference to FIG. 1, the data source identified as a relevant data source for the performance indicator (KPI) indicated by the received KPI name 302 is not necessarily the primary data source identified solely using the search keywords (search keyword 1 (primary data source condition 1), search keyword 2 (primary data source condition 2), . . . ). Therefore, when a difference between the primary data source and the relevant data source becomes apparent, the search keywords may be changed (updated), as shown in the record for “cost” in FIG. 3, in order to resolve the difference.

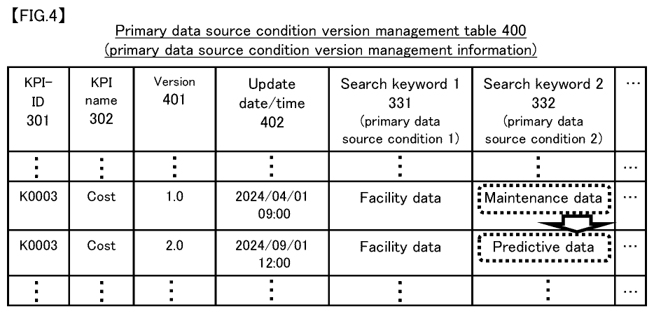

### 2.2.2. Primary Data Source Condition Version Management Table (FIG. 4)

FIG. 4 illustrates a primary data source condition version management table 400 (primary data source condition version management information).

When any of one or more search keywords (primary data source conditions) for a certain performance indicator (KPI) such as those shown in the record for “cost” in FIG. 3 is changed (updated), a new record is added to the primary data source condition version management table 400 in order to record the history before and after the change.

Each record of the primary data source condition version management table 400 (primary data source condition version information) may have fields for the KPI-ID 301, the KPI name 302 (performance indicator identification information), a version 401, an update date/time 402, and one or more search keywords. As shown in FIG. 4, if a record has two or more search keyword fields, each field may be designated as search keyword 1 (primary data source condition 1), search keyword 2 (primary data source condition 2), and so on. The number of search keywords per record is arbitrary.

The version 401 indicates the version of the search keywords for the performance indicator (KPI) indicated by the corresponding KPI name 302.

The update date/time 402 indicates the date and time when the corresponding search keywords came to be applied to the performance indicator (KPI). Alternatively, the update date and time 402 may indicate the date and time when the corresponding record was registered in the primary data source condition version management table 400.

### 2.2.3. Business Process List Table (Business Process List Information) (FIG. 5)

FIG. 5 shows the business process list table 500.

The business process list table 500 may be used by the system 100 to centrally manage each business process that handles each data source included in the data source group 211 (see FIG. 2).

Each record of the business process list table 500 may include fields for a business process ID 501 and a business process name 502 (business process identification information).

The business process ID 501 is an identification code number assigned to the record of the business process list table 500 and to the business process name 502. In the example of FIG. 5, the business process ID 501 consists of the letter “W” followed by four digits.

The business process name 502 is information for identifying the business process. In the example of FIG. 5, the business process name 502 is a human-readable name for the business process. FIG. 5 shows examples of the business process name 502 such as “proposal/consulting,” “implementation planning,” “operation,” “supply-demand management,” “maintenance,” and “update work,” but other names may also be used. In the example of FIG. 5, business processes corresponding to types or phases of business that may be performed for the same target matter are shown, but the business processes may alternatively be divided by the target matter of the business, or may be divided from both the viewpoints of the business target matter and the business type (phase). Generally, a business process name 502 may be defined for any business process that an organization or individual wishes to implement in performing business operations and that can be implemented on the basis of the data source group 221.

### 2.2.4. Data Source Characteristic Table (Data Source Characteristics Information) (FIG. 6)

FIG. 6 shows the data source characteristic table 600.

The data source characteristic table 600 holds information related to characteristics of respective data sources included in the data source group 211 (see FIG. 2).

Each record of the data source characteristic table 600 may include a data source ID 601, a data source name 602 (data source identification information), a business process name 502 (business process identification information), a last update date/time 603, an update frequency 604, and a reference frequency 605. Each record of the data source characteristic table 600 may also include fields for other characteristic information that is not shown in FIG. 6.

The data source ID 601 is an identification code number assigned to the record of the data source characteristic table 600 and to the data source name 602. In the example of FIG. 6, the data source ID 601 consists of the letter “D” followed by four digits.

The data source name 602 is information for identifying a data source. In the example of FIG. 6, the data source name 602 is a human-readable name for a data source. FIG. 6 shows examples of the data source name 602 such as “facility data 1,” “operating data 1,” “predictive data 1,” “planning data 1,” “operational data 1,” “transaction data 1,” “maintenance data 1,” “control data 1,” “traffic data 1,” “weather data 1,” “facility data 2,” and “operating data 2,” but other names may also be used.

The last update date/time 603 indicates the latest date and time when any of the items included in the corresponding record was updated.

The business process indicated by the business process name 502 is associated with the data source indicated by the data source name 602. A certain business process and a certain data source may be associated when the data source is accessed (updated or referenced) in implementing (executing) the business process. Alternatively, a business process and a data source may be associated for other reasons.

In the example of FIG. 6, one business process name 502 is associated with one data source name 602. However, multiple business process names 502 may be associated with one data source name 602.

In the example of FIG. 6, the same business process name 502 is associated with multiple data source names 602 that match the same search keyword (primary data source condition) (see FIG. 3). For example, in FIG. 6, both “facility data 1” and “facility data 2” as data source names 602 are associated with the same business process name 502, “operation.” However, even when multiple data source names 602 match the same search keyword (see FIG. 3), the respective data source names 602 may also be associated with mutually different business process names 502.

In this way, the associations between data sources and business processes may be defined flexibly.

The update frequency 604 indicates an index related to the frequency of update access performed on the data source indicated by the corresponding data source name 602. The reference frequency 605 indicates an index related to the frequency of reference access performed on the data source indicated by the corresponding data source name 602. Either the update frequency 604 or the reference frequency 605 may be an index obtained by applying prescribed normalization processing to, for example, the number of update accesses (or update access data amount) or the number of reference accesses (or reference access data amount) for the corresponding data source. For example, the quotient obtained by dividing the number of update accesses (or update access data amount) or the number of reference accesses (or reference access data volume) to the corresponding data source during a predetermined fixed period by a prescribed constant may be used as the update frequency 604 or the reference frequency 605.

Either the update frequency 604 or the reference frequency 605 may represent an index related to the number of update accesses (or update access data amount) or the number of reference accesses (or reference access data amount) performed within a predetermined period that is relatively close to the current time. That is, the update frequency 604 or the reference frequency 605 may be updated over time. Since the update frequency 604 or the reference frequency 605 is managed in this manner, appropriate handling is possible even when the importance of each data source changes over time.

### 2.2.5. Business Process Relevance Table (Business Process Relevance Information) (FIG. 7)

FIG. 7 shows a business process relevance table 700.

The business process relevance table 700 stores information related to the relevance between pairs of business processes. As long as the business process relevance table 700 stores a business process relevance value 701 for each pair of business process names 502 (business process identification information), the table may take any form, and is not limited to the matrix format shown in FIG. 7. For example, since information of the business process relevance value 701 shown in FIG. 7 overlaps redundantly, the business process relevance table 700 may alternatively be realized in a format with reduced redundancy of information of the business process relevance value 701.

In FIG. 7, the business process relevance value 701 for a pair of identical business process names 502 is set to 1.0. That is, for each business process, a business process relevance value 701 with respect to itself is set to 1.0. Since the value of the business process relevance value 701 for a pair of identical business process names 502 is self-evident, such self-evident values need not be stored in the business process relevance table 700.

The business process relevance value 701 for a pair of mutually different business process names 502 may be determined by any method. As will be described with reference to FIGS. 9 and 21, for example, business processes corresponding to respective data sources accessed by the same access source 902 (FIG. 9) within the same time period are recognized, and then the business process relevance value 701 for such a pair of business processes may be set relatively high. In this way, even when a direct relationship (relevance) between business processes is not defined, a pair of business processes that are implemented (executed) within the same time period from the same access source 902 can be identified through access histories to respective data sources, and a “loose” (not necessarily direct) relationship (relevance) between the business processes can thereby be reflected in the business process relevance value 701.

In FIG. 7, one row of the business process relevance table 700 forms an array (vector) of business process relevance value 701 for any of pairs of the business process corresponding to that row and various other business processes. In FIG. 7, for example, the array (vector) of the business process relevance value 701 for the pairs of the business process whose business process name 502 is “operation” and various other business processes is referred to as “operation” process relevance 711. Also in FIG. 7, the array (vector) of the business process relevance value 701 for the pairs of the business process whose business process name 502 is “maintenance” and various other business processes is referred to as “maintenance” process relevance 712.

### 2.2.6. Importance Score Table (Importance Score Information) (FIG. 8)

FIG. 8 shows the importance score table 800.

The importance score table 800 may hold a result in which an importance score 801 for each data source has been determined (calculated) for the KPI name 302 (performance indicator identification information) received by the system 100 from the user operation system 204.

In the example of FIG. 8, each record of the importance score table 800 may include fields for a data source ID 601, a data source name 602 (data source identification information), a business process name 502 (business process identification information), a last update date/time 603, an update frequency 604, a reference frequency 605, a business process relevance value 701 indicating the relationship (relevance) with the business process name (primary data source corresponding business process identification information 159) corresponding to the primary data source for the received KPI name 302, and an importance score 801.

FIG. 8 shows an example in which the business process names corresponding to the primary data source (primary data source corresponding business process identification information 159) for the received KPI name 302 are “operation” and “maintenance.” Accordingly, in FIG. 8, business process relevance values 701 included in an “operation” process relevance 711, which is an array (vector) of business process relevance values 701 indicating relationships (relevance) with a business process name corresponding to a primary data source for the received KPI name 302 (primary data source corresponding business process identification information 159), and business process relevance values 701 included in a “maintenance” process relevance 712 are included in each of the records shown in FIG. 8.

Furthermore, to facilitate understanding of the information used to determine (calculate) the importance score 801, each record shown in FIG. 8 displays various fields. However, some of these fields need not necessarily be included in the importance score table 800. For example, the fields for the business process name 502, the last update date/time 603, the update frequency 604, and the reference frequency 605 need only be referenced from the data source characteristic table 600 and need not necessarily be recorded in the records of the importance score table 800.

The data source ID 601, the data source name 602, the business process name 502, the last update date/time 603, the update frequency 604, and the reference frequency 605 in each record of the importance score table 800 are the same as those in the data source characteristic table 600 (data source characteristic information).

The “operation” process relevance 711 field in the example of FIG. 8 indicates a business process relevance value 701 corresponding to a pair consisting of the business process name 502 of the corresponding record and “operation,” which is one of the business process names corresponding to a primary data source for the received KPI name 302 (primary data source corresponding business process identification information 159).

In the example of FIG. 8, the “maintenance” process relevance 712 field indicates a business process relevance value 701 corresponding to a pair consisting of the business process name 502 of the corresponding record and “maintenance,” which is one of the business process names corresponding to a primary data source for the received KPI name 302 (primary data source corresponding business process identification information 159).

FIG. 8 illustrates an example in which two business process names (primary data source corresponding business process identification information 159) correspond to the primary data source for the received KPI name 302. However, the number of business process relevance value 701 fields included in the records of the importance score table 800 may vary depending on the number of business process names (primary data source corresponding business process identification information 159) corresponding to the primary data source.

The importance score 801 indicates the importance of the data source indicated by the data source name 602 in the corresponding record for the received KPI name 302. In the example of FIG. 8, the importance score 801 is determined by the sum of the index of the update frequency 604, the index of the reference frequency 605, the business process relevance value 701 derived from the “operation” process relevance 711, and the business process relevance value 701 derived from the “maintenance” process relevance 712. However, the importance score 801 may alternatively be determined (calculated) by other methods.

A data source whose corresponding importance score 801 is ranked higher is identified as a relevant data source for the received KPI name. In the example of FIG. 8, the data sources whose importance scores 801 rank within the top five are identified as relevant data sources. In identifying relevant data sources, a criterion that the importance score 801 is within a prescribed ranking may be applied, or a criterion that the value of the importance score 801 is equal to or larger than a prescribed threshold may be applied.

As shown in FIG. 8, the data source name 602 of the relevant data source may be referred to as the relevant data source name 802. Furthermore, as shown in FIG. 8, the various pieces of information related to the relevant data source may collectively be referred to as the relevant data source related information 803.

### 2.2.7. Data Access Log Table (Data Access Log Information) (FIG. 9)

FIG. 9 shows the data access log table 900.

The data access log table 900 stores histories of access to the data source group 211 (see FIG. 2) when business processes are implemented (executed).

Each record of the data access log table 900 may include a timestamp 901, an access source 902, an access log 903, and a business process name 502.

The timestamp 901 may indicate the time when the data source shown in the access log 903 was accessed. Alternatively, the timestamp 901 may indicate when the corresponding record was registered in the data access log table 900. The access source 902 indicates the source which has accessed the data source shown in the corresponding access log 903. In FIG. 9, examples of fields of the access source 902 include “data analyst A” that indicates a data analyst operation system 202 (see FIG. 2) operated by a data analyst A, “data analyst C” that indicates another data analyst operation system 202 operated by a data analyst C, and “data analysis system B” which is a data analysis system 203 (see FIG. 2).

The access log 903 indicates a log of access made from the access source 902 to the data source. In the example of FIG. 9, the access log 903 may be a command used for the access or a Uniform Resource Locator (URL) to which an Application Programming Interface (API) call is made.

In the example of FIG. 9, for example, an SQL command “SELECT Facility Data1.Name, Maintenance Data1.Asset FROM Facility Data1 INNER JOIN Maintenance Data1 ON Facility Data1.AssetID=Maintenance Data1.AssetID;” indicates that, when the AssetID field included in a record of the data source “Facility Data1” matches the AssetID field included in a record of the data source “Maintenance Data1,” the Name field is extracted from the matching record of the data source “Facility Data1,” and the Asset field is extracted from the matching record of the data source “Maintenance Data1,” thereby obtaining a new table by means of an inner join (INNER JOIN).

In the example of FIG. 9, for example, an SQL command “SELECT * FROM Maintenance Data2 WHERE AssetID=A0001” indicates that, when the AssetID included in a record of the data source “Maintenance Data2” is A0001, all fields included in such a record are extracted.

In the example of FIG. 9, a URL “http://xxx.com/asset_plan_data1,” which is an access destination for an API call, indicates that information on a group of records included in the data source “Plan Data1” is obtained.

The business process name 502 (business process identification information) in each record of the data access log table 900 indicates a business process estimated to be involved in the access to the data source shown by the corresponding record. For example, the business process name 502 may be estimated using the access destination data source (data source name 602 (data source identification information)) shown in the access log 903 and the data source characteristic table 600 (data source characteristic information).

As will be described in detail with reference to FIG. 21, when business process relevance value 701 corresponding to a pair of business process names 502 is determined (calculated) using information included in the data access log table 900, each record of the data access log table 900 may be distributed into groups (divided logs) classified by access source 902 and by a time period to which a timestamp 901 belongs.

### 2.3. Outline of GUIs Presented by System of the Embodiment to User Operation System

The following outlines the graphical user interface (GUI) that can be presented to the user operation system 204 by the system 100.

### 2.3.1. Data Source Identification Graphical User Interface (GUI)

A data source identification graphical user interface (data source identification GUI) is used for inputting, from the user operation system 204 to the system 100, a KPI name 302 (performance indicator identification information), which is identification information of a performance indicator (KPI) to be considered, and for presenting, from the system 100 to the user operation system 204, relevant data source related information 803.

The data source identification graphical user interface may be mainly controlled by the KPI name receiving unit 1600 (performance indicator identification information receiving unit) and the relevant data source related information display control unit 1800 in the system 100.

The user operation system 204 may also be involved in the control of display and other aspects of the data source identification graphical user interface.

The data source identification graphical user interface may be either or both of a form input type and a chat type. Each type will be described below.

### 2.3.1.1. Form Input Type Data Source Identification GUI (FIG. 10)

FIG. 10 illustrates a form input type data source identification graphical user interface 1000 (form input type data source identification GUI).

As shown in FIG. 10, an area for receiving input of the KPI name 302 (performance indicator identification information) from the user operation system 204 may be provided in an upper portion of the form input type data source identification graphical user interface 1000, and an area for presenting the relevant data source related information 803 from the system 100 may be provided in a lower portion.

In the upper portion of FIG. 10, a KPI name selection pull-down menu 1011 (performance indicator identification information selection pull-down menu) and a relevant data source identification process start icon 1015 are provided. Each selectable option in the KPI name selection pull-down menu 1011 may include a combination of a KPI-ID 301 and a KPI name 302 corresponding to a record of the KPI analysis table 300 (performance indicator analysis information) (or may include only the KPI name 302). Alternatively, a radio button form may be used instead of the KPI name selection pull-down menu 1011.

In the lower portion of FIG. 10, a relevant data source related information table 1020 may be displayed. For each record of the relevant data source related information table 1020, some or all of a data source name 602 (relevant data source name 802), a business process name 502, an importance score 801, and supplemental information may be displayed. The supplemental information may indicate matters estimated to be the factors by which the corresponding record has been identified as a relevant data source.

### 2.3.1.2. Chat Type Data Source Identification GUI (FIG. 11)

FIG. 11 shows a chat type data source identification graphical user interface 1100 (chat type data source identification GUI).

As shown in FIG. 11, a user input field 1140 is provided on a left side of the chat type data source identification graphical user interface 1100, and a system output field 1150 may be provided on a right side. (The left-right arrangement may be reversed.)

The user input field 1140 on the left side in FIG. 11 may allow a user to input, in natural-language free text, a request for identifying a relevant data source that is a data source related to the performance indicator (KPI) indicated by the KPI name 302 (performance indicator identification information), via an input device (such as a keyboard, and a touch sensor) included in the user operation system 204. As shown in FIG. 11, the number of relevant data sources may also be designated via free-form natural language text.

The system output field 1150 on the right side in FIG. 11 may display a natural language sentence indicating information included in the relevant data source related information 803 (see FIG. 8). As shown on the right side in FIG. 11, some or all of the data source name 602 (relevant data source name 802), the importance score 801, and the supplementary information may be displayed. The supplementary information may indicate factors by which the corresponding record has been identified as a relevant data source. Although not shown on the right side in FIG. 11, a business process name 502 may also be displayed in the system output field 1150.

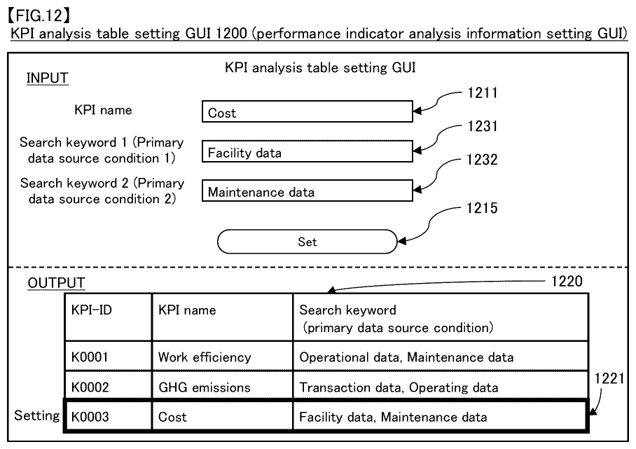

### 2.3.2. KPI Analysis Table Setting GUI (Performance Indicator Analysis Information Setting GUI) (FIG. 12)

The KPI analysis table setting graphical user interface 1200 is used to input information to be stored in the KPI analysis table 300 (performance indicator analysis information) from the user operation system 204 to the system 100.

The KPI analysis table setting graphical user interface 1200 may be mainly controlled by a KPI analysis table setting receiving unit 2200 (performance indicator analysis information setting receiving unit) in the system 100. Note that the user operation system 204 may also be involved in controlling the display within the KPI analysis table setting graphical user interface 1200 and other aspects.

FIG. 12 shows the KPI analysis table setting graphical user interface 1200.

As shown in FIG. 12, an area for receiving, from the user operation system 204, input of a KPI name 302 (performance indicator identification information) and one or more search keywords (primary data source condition) is provided in an upper portion of the KPI analysis table setting graphical user interface 1200. An area for presenting the state of the KPI analysis table 300 may be provided in a lower portion.

In an upper portion of FIG. 12, a KPI name input field 1211 (performance indicator identification information input field), one or more search keyword input fields (primary data source condition input fields), and a KPI analysis table setting icon 1215 (performance indicator analysis information setting icon) are provided. In the example of FIG. 12, as the one or more search keyword input fields, an input field 1231 for a search keyword 1 (input field for a primary data source condition 1) and an input field 1232 for a search keyword 2 (input field for a primary data source condition 2) are shown, but the number of such input fields is arbitrary.

For any of the input fields of FIG. 12, the user may input a KPI name 302 or a search keyword through an input device (such as a keyboard and a touch sensor) included in the user operation system 204.

A KPI analysis table status 1220 (performance indicator information status) may be displayed in the lower portion of FIG. 12. The KPI analysis table status 1220 indicates part or all of the information included in the KPI analysis table 300 in which a new setting is reflected.

In response to a new setting related to the KPI analysis table 300 being input in the upper portion of FIG. 12, the lower portion of FIG. 12 may display part or all of information included in the KPI analysis table 300 reflecting the new setting. At the time, a portion of record changed by the new setting may be highlighted by a thick border or by coloring the portion, as indicated by the changed record highlighting display 1221.

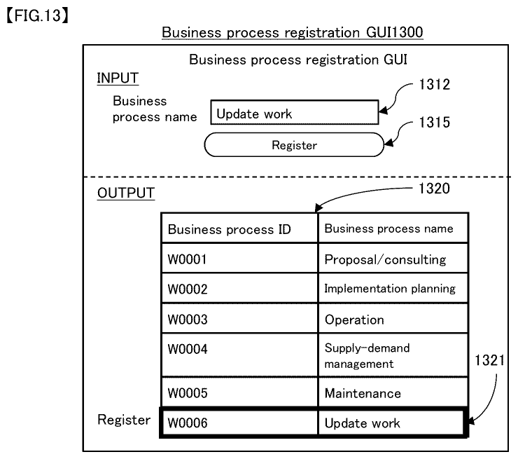

### 2.3.3. Business Process Registration GUI (FIG. 13)

The business process registration graphical user interface 1300 (business process registration GUI) is used for inputting into the system 100, from the user operation system 204, information to be held in the business process list table 500 (business process list information).

The business process registration graphical user interface 1300 may be mainly controlled by a business process registration receiving unit 2300 in the system 100. The user operation system 204 may also be involved in the display-related control of the business process registration graphical user interface 1300.

FIG. 13 shows the business process registration graphical user interface 1300.

As shown in FIG. 13, an area for receiving input of the business process name 502 (business process identification information) from the user operation system 204 is provided in an upper portion of the business process registration graphical user interface 1300. An area for presenting the status of the business process list table 500 may be provided in a lower portion.

In the upper portion of FIG. 13, a business process name input field 1312 (business process identification information input field) and a business process list table setting icon 1315 (business process list information setting icon) are provided. In the business process name input field 1312 (business process identification information input field), the user may input a business process name 502 via an input device (such as a keyboard and a touch sensor) included in the user operation system 204.

In the lower portion of FIG. 13, a business process list table status 1320 (business process list information status) may be displayed. The business process list table status 1320 shows part or all of the information included in the business process list table 500.

In response to a new setting for the business process list table 500 being input via the upper portion of FIG. 13, part or all of the information included in the business process list table 500 reflecting the new setting may be shown in the lower portion of FIG. 13. In this case, a portion of record changed by the new setting may be highlighted by a thick border or by coloring the portion, as indicated by the changed record highlighting display 1321.

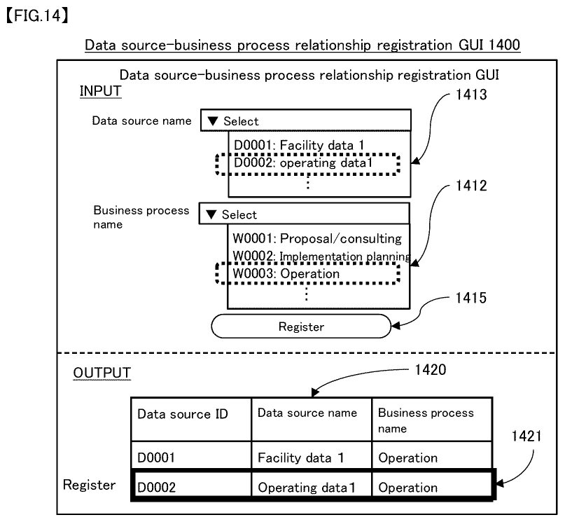

### 2.3.4. Data Source-Business Process Relationship Registration GUI (FIG. 14)

A data source-business process relationship registration graphical user interface 1400 (data source-business process relationship registration GUI) is used for inputting, from the user operation system 204 to the system 100, a setting related to the relationship between a data source and a business process among the information included in the data source characteristic table 600 (data source characteristic information).

The data source-business process relationship registration graphical user interface 1400 may be mainly controlled by the data source-business process relationship registration receiving unit 2400 in the system 100. The user operation system 204 may also be involved in controlling display and other aspects of the data source-business process relationship registration graphical user interface 1400.

FIG. 14 shows the data source-business process relationship registration graphical user interface 1400.

As shown in FIG. 14, an area for receiving input of a data source name 602 (data source identification information) and a business process name 502 (business process identification information) from the user operation system 204 is provided in an upper portion of the data source-business process relationship registration graphical user interface 1400, and an area for presenting the status of the data source characteristic table 600 may be provided in a lower portion.

In an upper portion of FIG. 14, a data source name selection pull-down menu 1413 (data source identification information selection pull-down menu), a business process name selection pull-down menu 1412 (business process identification information selection pull-down menu), and a data source-business process relationship registration icon 1415 are provided.

For each selection option shown in the data source name selection pull-down menu 1413, a combination of a data source ID 601 and a data source name 602 in each record of the data source characteristic table 600 may be presented (or only the data source name 602 may be indicated).

For each selection option shown in the business process name selection pull-down menu 1412, a combination of a business process ID 501 and a business process name 502 in each record of the business process list table 500 may be presented (or only the business process name 502 may be indicated).

One or both of the data source name selection pull-down menu 1413 and the business process name selection pull-down menu 1412 may be replaced with radio-button form.

The data source-business process relationship registration graphical user interface 1400 may also include a data source name input field to allow text input of a new data source name 602.

In a lower portion of FIG. 14, a data source characteristic table status 1420 (data source characteristic information status) may be displayed. The data source characteristic table status 1420 indicates part or all of the information included in the data source characteristic table 600.

In response to a new setting related to the relationship between a data source and a business process input via the upper portion of FIG. 14, part or all of the information included in the data source characteristic table 600 that reflects the new setting may be shown in the lower portion of FIG. 14. In this case, a portion of record changed by the new setting may be highlighted by a thick border, as indicated by a changed record highlighting display 1421, or by coloring the portion.

### 3. Computer Architecture for Implementing the Embodiment of the Disclosure (FIG. 25)

FIG. 25 shows a computer architecture 2500 for implementing the system 100 of the embodiment of the present disclosure. The computer architecture 2500 shown in FIG. 25 may also be referred to as an information processing apparatus or an information processing system. (The computer architecture 2500, which constitutes an information processing apparatus or an information processing system, may be understood as what performs the method.)

To implement the system 100, a arithmetic processing device 2501, a storage device 2502, a non-volatile recording medium (recording device) 2503, an external recording medium drive 2504, an input device 2506, a display or output device 2507, a communication device 2508, an external input/output port 2509, and a reading device 2510, in part or its entirety, may be interconnected via an interconnection unit 2511. (Note that the interconnection unit 2511 may be partly or entirely implemented as a network. In such a case, the system 100 is implemented by multiple devices (computers) connected via the network.) A configuration including the storage device 2502 and the non-volatile recording medium (recording device) 2503 (the dashed portion in FIG. 25) may be referred to as the memory hierarchy 2540.

The arithmetic processing device 2501 may include, for example, one or more processors. Examples of such processors include a CPU, an MPU, or a GPU. Alternatively, the term processor as used herein may refer to any other semiconductor device that performs prescribed processing. Furthermore, the arithmetic processing device 2501 may include one or more (micro) processors.

The storage device 2502 may be, for example, a memory. The non-volatile recording medium (recording device) 2503 may be, for example, a non-volatile memory (such as a flash memory) or a non-volatile disk device. The external recording medium drive 2504 may be, for example, a disk drive. The input device 2506 may be, for example, a mouse, keyboard, or touch panel. The display or output device 2507 may be, for example, a display, printer, or speaker. The communication device 2508 may be, for example, a wired-communication device or a wireless communication device. The communication device 2508 may be a network interface card (NIC). The interconnection unit 2511 may be, for example, a bus or a crossbar switch. (As noted above, part or all of the interconnection unit 2511 may be a network.)

In the nonvolatile recording medium (recording device) 2503, various programs included in a program group 2531 (for example, programs for implementing the functional configuration according to the present disclosure, such as programs for implementing the respective functional units realized by the system 100, which as a whole may be referred to as a program according to the present disclosure), various data groups included in a data group 2532, or information included in various pieces of information 2533 may be recorded.

The program group 2531 may include respective programs for implementing the respective functional units denoted as “units” in the drawings. Note that some of the above programs may be integrated into a single program, and any of the above programs may alternatively be divided into multiple programs. The data group 2532 may include information (data, etc.) handled by the functional units. For example, the data group 2532 may include information constituting each information group or data group handled by the functional units. (Note that part or all of the information included in an information group or data group may be stored in the storage device 2502 (memory).) The data group 2532 may include various tables (information) shown in FIG. 1 or FIG. 2. (some of these kinds of information that may be included in the data group 2532 may be stored in the storage device 2502 (memory) rather than being recorded in the nonvolatile recording medium (recording device) 2503.)

In place of the above, part or all of the various programs included in the program group 2531, the various pieces of information groups or data groups included in the data group 2532, or the information included in the various kinds of information 2533 may be acquired from outside of the configuration shown in FIG. 25. For example, such information may be provided from a distribution server.

The external recording medium drive 2504 can be connected with an external recording medium 2505. The external recording medium 2505 may be, for example, a portable recording disk or a nonvolatile memory (e.g., flash memory). In addition, information similar to the various programs included in the program group 2531, the various pieces of information groups or data groups included in the data group 2532, or the information included in the various pieces of information 2533 may be transferred from the external recording medium 2505 to the nonvolatile recording medium (recording device) 2503 or the storage device 2502 and stored therein.

The external recording medium drive 2504 and the external recording medium 2505 may also be connected to the system 100 shown in FIG. 25 via a network.

The various programs included in the program group 2531, the various pieces of information groups or data groups included in the data group 2532, or the information included in the various kinds of information 2533 may alternatively be provided via the communication device 2508, the external input/output port 2509, the input device 2506, or the reading device 2510, and recorded or stored in the nonvolatile recording medium (recording device) 2503 or the storage device 2502.

Various programs included in the program group 2531 may be loaded into the storage device 2502 (for example, from the non-volatile recording medium (recording device) 2503) to enable the architecture of FIG. 25 to function as the system 100, functional units in the system 100, or parts of the functional units (to execute one or a series of processes (steps)). The loaded programs are indicated as 2521 in FIG. 25. The arithmetic processing device 2501 may then execute the program 2521 (using, as required, the various pieces of information groups or data groups included in the data group 2532 existing in the non-volatile recording medium (recording device) 2503, or information included in the various pieces of information 2533). By execution of the program 2521, the functions of the system 100, the functional units in the system 100, or parts of the functional units are realized (one or a series of processes (steps) are executed). At the time, various buffers 2523 temporarily formed in the storage device 2502 may also be utilized as appropriate.

As described above, an information processing system or an information processing apparatus having one or more processors and a memory hierarchy is caused to execute programs corresponding to part or all of the functional units in the embodiment of the present disclosure. Therefore, implementation of the system 100 according to the embodiment of the present disclosure can be realized through development of such programs.

### 4. Functional Configuration, Processing, and Information of the Embodiment

The following describes the functional configuration of the system 100, the processing performed by the functional units of the system 100, and information handled by the functional units of the system 100.

### 4.1. Identification of Relevant Data Sources for Performance Indicators (KPIs)

The following describes a series of processes from receipt, by the system 100, of a KPI name 302 (performance indicator identification information) from the user operation system 204, through identification of relevant data sources and relevant data source related information 803 by the system 100, to presentation of the relevant data source related information 803 to the user operation system 204, as well as related processes, and the functional configuration of the system 100, the processing performed by the system, and the information handled by the system.

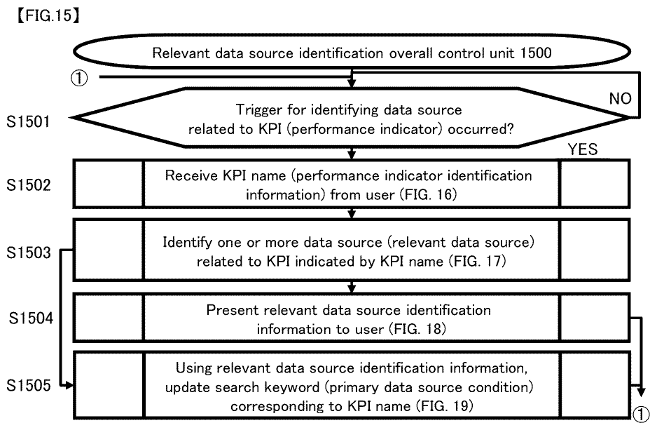

### 4.1.1. Overall Control for Identification of Relevant Data Sources for Performance Indicator (KPI) (FIG. 15)

For identification of relevant data sources for a performance indicator (KPI), as shown in FIG. 2, a relevant data source identification overall control unit 1500 may control, as appropriate, a KPI name receiving unit 1600 (performance indicator identification information receiving unit), a relevant data source identifying unit 1700, a relevant data source related information display control unit 1800, and a primary data source condition updating unit 1900.

FIG. 15 is a flowchart for illustrating processing performed by the relevant data source identification overall control unit 1500.

In step 1501 of FIG. 15, the relevant data source identification overall control unit 1500 determines whether a trigger for identifying relevant data sources for a performance indicator (KPI) has occurred. For example, step 1501 may be triggered when a user provides an instruction, via the user operation system 204, requesting processing to identify relevant data sources for a performance indicator (KPI) for consideration by the user. If the determination result in step 1501 is affirmative, the control proceeds to step 1502. If the determination result in step 1501 is negative, step 1501 is repeated.

In step 1502 of FIG. 15, the relevant data source identification overall control unit 1500 requests the KPI name receiving unit 1600 to receive a KPI name 302 (performance indicator identification information) from the user operation system 204. Upon receiving this request, the KPI name receiving unit 1600 performs processing shown in FIG. 16 which will be described later. When reception of the KPI name 302 by the KPI name receiving unit 1600 is completed, the control proceeds to step 1503.

In step 1503 of FIG. 15, the relevant data source identification overall control unit 1500 requests the relevant data source identifying unit 1700 to identify relevant data sources and relevant data source related information 803 for the performance indicator (KPI) indicated by the received KPI name 302. In response to this request, the relevant data source identifying unit 1700 performs the processing shown in FIG. 17, which will be described later. (An outline of the processing shown in FIG. 17 has already been described with reference to FIG. 1.) When identification of the relevant data sources and the relevant data source related information 803 is completed, steps 1504 and 1505 are executed either sequentially or in parallel.

In step 1504 of FIG. 15, the relevant data source identification overall control unit 1500 requests the relevant data source related information display control unit 1800 to present the identified relevant data source related information 803 to the user operation system 204.

In response to this request, the relevant data source related information display control unit 1800 performs the processing shown in FIG. 18, which will be described later.

In step 1505 of FIG. 15, the relevant data source identification overall control unit 1500 requests the primary data source condition updating unit 1900 to update, as appropriate, search keywords (primary data source conditions) corresponding to the received KPI name 302 by using the identified relevant data source name 802, the identified relevant data source related information 803, or the importance score 801 for each data source determined by the relevant data source identifying unit 1700 (see FIG. 8). In response to this request, the primary data source condition updating unit 1900 performs the processing shown in FIG. 19, which will be described later.

When presentation of the relevant data source related information 803 to the user operation system 204 is completed and processing for updating, as appropriate, the search keywords corresponding to the received KPI name 302 is completed, the control returns to step 1501.

As described above, under overall control by the relevant data source identification overall control unit 1500, processing related to identification of a relevant data source for a performance indicator (KPI) is performed. When a functional unit that performs overall control and a functional unit that handles individual processing are separated, for example, when the functional units are implemented by execution of a program, management of module granularity for each program for implementing the functional units can be realized.

### 4.1.2. Functional Configuration, Processing, and Information Related to Reception of KPI Name (Performance Indicator Information) (FIG. 16)

This section describes the functional configuration of the system 100, processing performed by the system, and information handled by the system when a KPI name 302 is received from the user operation system 204. A functional unit mainly responsible for performing the processing described in this section is a KPI name receiving unit 1600 (performance indicator identification information receiving unit). Through the functional configuration, processing, and information which will be described, the system 100 can receive the KPI name 302 from the user operation system 204 via a graphical user interface (GUI) that is easy to understand for a user operating the user operation system 204. For example, by providing one or both of an input type form GUI and a chat type GUI, convenience for the user operating the user operation system 204 is improved.

FIG. 16 is a flowchart for illustrating processing by the KPI name receiving unit 1600.

In step 1601 of FIG. 16, the KPI name receiving unit 1600 determines whether an instruction (request) to receive a KPI name 302 issued by the user operation system 204 has been received from the relevant data source identification overall control unit 1500. The instruction (request) may be issued near the beginning of step 1502 of FIG. 15. If the determination result in step 1601 is affirmative, the control proceeds to step 1602. If the determination result in step 1601 is negative, step 1601 is repeated.

In step 1602 of FIG. 16, the KPI name receiving unit 1600 determines whether to use a form input type or a chat type as a data source identification graphical user interface (data source identification GUI) to be provided to the user operation system 204. For example, when the system 100 implements only one of a form input type or a chat type as the data source identification graphical user interface, the implemented type is selected. When the system 100 implements both types, an instruction indicating selection of a type of the data source identification graphical user interface from the user operation system 204 may be provided to the system 100. If the determination result in step 1602 is selection of a form type, the control proceeds to step 1603. If the determination result in step 1602 indicates selection of a chat type, the control proceeds to step 1605.

In step 1603 of FIG. 16, the KPI name receiving unit 1600 controls display such that a screen based on a form input type data source identification graphical user interface 1000 (form input type data source identification GUI), for example as shown in FIG. 10, is displayed for example on a display of the user operation system 204. The user operation system 204 may also be involved in the display control.

The user selects a KPI name 302 included in the KPI name selection pull-down menu 1011 (performance indicator identification information selection pull-down menu) in FIG. 10 by using for example an input device of the user operation system 204 (for example, a mouse or a touch panel), and then clicks the relevant data source identification process start icon 1015. As a result, information indicating the KPI name 302 selected by the user is transmitted from the user operation system 204 to the system 100.

Alternatively, instead of the KPI name selection pull-down menu 1011 in FIG. 10, an input field for character input of the KPI name 302 may be provided. In this case, the user performs character input of the KPI name 302 into the input field by using for example an input device or of the user operation system 204 (for example, a keyboard or a touch panel), and then clicks the relevant data source identification process start icon 1015 by using an input device (for example, a mouse or a touch panel). As a result, information indicating the KPI name 302 input by the user as characters is transmitted from the user operation system 204 to the system 100.

In step 1604 of FIG. 16, the KPI name receiving unit 1600 recognizes the KPI name 302 selected or character-input (directly input) by the user in step 1603, and the recognition result is transmitted to the relevant data source identification overall control unit 1500. After step 1604, the control returns to step 1601.

In step 1605 of FIG. 16, the KPI name receiving unit 1600 controls display such that a screen based on the chat type data source identification graphical user interface 1100, for example as shown in FIG. 11, is displayed for example on a display of the user operation system 204. The user operation system 204 may also be involved in this display control. The user inputs, into a user input field 1140 in FIG. 11, a sentence indicating a request for identification of a relevant data source for a performance indicator (KPI) for consideration by using natural language, by using an input device or the like of the user operation system 204 (for example, a keyboard or a touch panel), as free-form composition. In the example of FIG. 11, a sentence “Please tell me five data sources related to the “cost” KPI.” is input into the user input field 1140. As a result, information indicating the sentence input into the user input field 1140 is transmitted from the user operation system 204 to the system 100.

In step 1606 of FIG. 16, the KPI name receiving unit 1600 recognizes information indicating the sentence input in step 1605 by the user (free-form composition).

In step 1607 of FIG. 16, the KPI name receiving unit 1600 recognizes the KPI name 302 from the sentence recognized in step 1606 (free-form composition). At the time, the KPI name receiving unit 1600 may input the sentence recognized in step 1606 (free-form composition) to a certain trained model, and recognize the KPI name 302 as an output from the trained model. Alternatively, the KPI name receiving unit 1600 may extract the KPI name 302 from the sentence recognized in step 1606 (free-form composition) on the basis of a certain rule. After performing recognition or extraction of the KPI name 302, the KPI name receiving unit 1600 transmits the result to the relevant data source identification overall control unit 1500. Thereafter, the control returns to step 1601.

### 4.1.3. Functional Configuration, Processing, and Information Related to Identification of Relevant Data Sources for Performance Indicators (KPIs) (FIG. 17)

This section describes the functional configuration of a system 100, processing performed by the system, and information handled by the system when identifying a relevant data source (relevant data source name 802) and relevant data source related information 803 for a performance indicator (KPI) indicated by a KPI name 302 (performance indicator identification information) received from the user operation system 204. A functional unit mainly responsible for performing the processing described in this section is a relevant data source identifying unit 1700.

With the functional configuration, processing, and information which will be described below, not only a search keyword (for example, the search keyword 331 (or 332) (primary data source condition)) but also information related to characteristics of each data source indicated by the data source characteristic table 600 (data source characteristic information) and relationships between business processes indicated by the business process relevance table 700 (business process relevance information) are reflected, so that a relevant data source for a performance indicator (KPI) can be identified. Accordingly, a relevant data source that is difficult for a user to notice can also be identified.

The data source characteristic table 600 and the business process relevance table 700 may be updated as appropriate in accordance with changes in circumstances around the data source group 211 shown in FIG. 2 (and a business process group executed by using the data source group 211). Further, a search keyword (for example, the search keyword 331 (or 332)) may also be updated as appropriate by using a determination result (calculation result) of the importance score 801 for each data source name 602 (data source identification information). Accordingly, in response to changes in circumstances, a relevant data source for a performance indicator (KPI) can be appropriately identified.

In the following description, processing performed by the relevant data source identifying unit 1700 will be described with reference to FIG. 17, while the description of matters related to processing performed by the relevant data source identifying unit 1700 already described with reference to FIG. 1, and matters related to aspects of various tables already described with reference to FIGS. 3, 6, 7, and 8 may not be repeated.

FIG. 17 is a flowchart for illustrating processing performed by the relevant data source identifying unit 1700.

In step 1701 of FIG. 17, the relevant data source identifying unit 1700 determines whether it has received a request from the relevant data source identification overall control unit 1500 to identify the relevant data source for a performance indicator (KPI) indicated by the KPI name 302 received from the user operation system 204. This instruction (request) may be issued near the beginning of step 1503 in FIG. 15. If the determination result in step 1701 is affirmative, the control proceeds to step 1702. If the determination result in step 1701 is negative, step 1701 is repeated.

In step 1702 of FIG. 17, the relevant data source identifying unit 1700 identifies a search keyword by using the KPI name 302 received from the user operation system 204 and the KPI analysis table 300 (performance indicator analysis information). For example, the relevant data source identifying unit 1700 may compare, with respect to the KPI name 302, the KPI name received from the user operation system 204 with those included in respective records of the KPI analysis table 300, and identify a record in which the two match. The relevant data source identifying unit 1700 identifies search keywords included in the identified record. In the example of FIG. 3, the relevant data source identifying unit 1700 identifies a search keyword 1 (primary data source condition 1) and a search keyword 2 (primary data source condition 2) included in the identified record. In the example of FIG. 3, when the received KPI name is “cost”, the relevant data source identifying unit 1700 identifies, as search keywords, the terms “facility data” and “maintenance data.” The relevant data source identifying unit 1700 may identify search keywords corresponding to the number of search keywords included in the record. Since the number of search keywords associated with one KPI name 302 may be any number of one or more, appropriate settings can be achieved even when the breadth of data sources that may serve as primary data sources varies depending on characteristics of the KPI name 302 (performance indicator).

In step 1703 of FIG. 17, the relevant data source identifying unit 1700 selects one of the search keywords identified in step 1702.

In step 1704 of FIG. 17, the relevant data source identifying unit 1700 uses the search keyword selected in the immediately preceding step 1703 and the data source characteristic table 600 to identify the primary data source (the data source name of the primary data source) for the performance indicator (KPI) indicated by the received KPI name 302. In other words, the relevant data source identifying unit 1700 identifies the primary data source identification information 169 shown in FIG. 1.

For example, the relevant data source identifying unit 1700 may identify, among data source names 602 (data source identification information) included in respective records of the data source characteristic table 600, those that include a term of the search keyword selected in step 1703, and set the identified data source names 602 as data source names of primary data sources. In the example of FIG. 6, when the search keyword selected in the immediately preceding step 1703 is “facility data,” “facility data 1” and “facility data 2” are identified as data source names of primary data sources. In this manner, one or more primary data sources may be identified for one search keyword. For example, even when a plurality of data sources corresponding to the same search keyword come to exist over time (or due to some other circumstance), all of the plurality of data sources can be treated as primary data sources.

In step 1705 of FIG. 17, the relevant data source identifying unit 1700 selects one of the primary data sources (data source names of primary data sources) identified in the immediately preceding step 1704.

In step 1706 of FIG. 17, the relevant data source identifying unit 1700 identifies, by using the data source characteristic table 600, a business process corresponding to the primary data source (data source name of the primary data source) selected in the immediately preceding step 1705, the business process being a business process name 502 (business process identification information). That is, the relevant data source identifying unit 1700 identifies primary data source corresponding business process identification information 159 in FIG. 1.

For example, the relevant data source identifying unit 1700 may identify, among records of the data source characteristic table 600, a business process name 502 included in a record for the primary data source selected in the immediately preceding step 1705, and set the identified business process name 502 as a business process name corresponding to the primary data source (primary data source corresponding business process identification information 159). In the example of FIG. 6, when the data source name of the primary data source selected in the immediately preceding step 1705 is “facility data 1,” “operation” is identified as a business process name corresponding to the primary data source (primary data source corresponding business process identification information 159). In the example of FIG. 6, since one business process name 502 exists for one data source name 602, one business process name corresponding to the primary data source (primary data source corresponding business process identification information 159) is identified by one execution of step 1706. However, the present disclosure is not limited thereto.

By one execution of step 1706, two or more business process names 502 may be identified as business process names corresponding to the primary data source (primary data source corresponding business process identification information 159). In this manner, the number of business processes corresponding to one primary data source can be flexibly set, and step 1706 enables all of such business processes to be identified.

In step 1707 of FIG. 17, the relevant data source identifying unit 1700 determines, by using the business process relevance table 700, a business process relevance value 701 between a business process corresponding to the primary data source identified in the immediately preceding step 1706 (the business process indicated by the primary data source corresponding business process identification information 159) and each business process.

In the example of FIG. 7, when the business process name corresponding to the primary data source identified in the immediately preceding step 1706 (primary data source corresponding business process identification information 159) is “operation,” the business process relevance value 701 between the business process “operation” and the business process “proposal/consulting” is determined as “0.40,” the business process relevance value 701 between the business process “operation” and the business process “implementation planning” is determined as “0.80,” the business process relevance value 701 between the business process “operation” and the business process “demand and supply management” is determined as “0.75,” the business process relevance value 701 between the business process “operation” and the business process “maintenance” is determined as “0.80,” and the business process relevance value 701 between the business process “operation” and the business process “update work” is determined as “0.40.” The business process relevance value 701 between the business process “operation” and the business process “operation” may be set to “1.00.” When the business process name corresponding to the primary data source (primary data source corresponding business process identification information 159) is “operation,” an array (vector) of business process relevance values 701 may be referred to as “operation” process relevance 711.

When a plurality of business process names corresponding to the primary data source (primary data source corresponding business process identification information 159) exist as identified in the immediately preceding step 1706, determination of an array (vector) of business process relevance values 701 as described above may be performed for each of the identified business process names corresponding to the primary data source (primary data source corresponding business process identification information 159).

As already described and as will be described later with reference to FIG. 21, the business process relevance value 701 can indicate not only a direct relationship (relevance) between business processes but also an “indirect” relationship (relevance) between business processes. That is, even when a direct relationship (relevance) between business processes is not explicitly set, the business process relevance value 701 can indicate a relationship (relevance) between business processes that are estimated to have been implemented (executed) in the same time period by the same access source 902 (see FIG. 9). Accordingly, business processes related to a performance indicator (KPI) can be flexibly identified.

In step 1708 of FIG. 17, the relevant data source identifying unit 1700 determines whether all primary data sources (data source names of primary data sources) identified in the immediately preceding step 1704 corresponding to the search keyword selected in the immediately preceding step 1703 have been selected in step 1705. For example, when the search keyword selected in the immediately preceding step 1703 is “facility data” and the primary data sources (data source names of primary data sources) identified in the immediately preceding step 1704 are “facility data 1” and “facility data 2,” it is determined whether execution of step 1705 in which “facility data 1” is selected and execution of step 1705 in which “facility data 2” is selected have been performed. (However, in the example of FIG. 6, since a business process name 502 corresponding to “facility data 1” and a business process name 502 corresponding to “facility data 2” are both the same, namely “operation,” step 1707 does not need to be executed redundantly in this case.) If the determination result in step 1708 is affirmative, the control proceeds to step 1709. If the determination result in step 1708 is negative, the control returns to step 1705, and a primary data source (data source name of a primary data source) that has not yet been selected is selected.

In step 1709 of FIG. 17, the relevant data source identifying unit 1700 determines whether all search keywords identified in step 1702 have been selected in step 1703. For example, when the search keywords identified in step 1702 are “facility data” and “maintenance data,” it is determined whether execution of step 1705 in which “facility data” is selected and execution of step 1705 in which “maintenance data” is selected have been performed. If the determination result in step 1709 is affirmative, the control proceeds to step 1710. If the determination result in step 1709 is negative, the control returns to step 1703, and a search keyword that has not yet been selected is selected.

In step 1710 of FIG. 17, the relevant data source identifying unit 1700 identifies, by using the data source characteristic table 600, for each data source (data source name 602), a corresponding business process (business process name 502) and information related to other characteristics of the data source. In the example of FIG. 6, as information related to other characteristics of the data source, at least one or both of an index related to an update frequency 604 and an index related to a reference frequency 605 may be identified.

In step 1711 of FIG. 17, the relevant data source identifying unit 1700 determines (calculates), for each data source (data source name 602), an importance score 801 for a performance indicator (KPI) indicated by the KPI name 302 received from the user operation system 204.

Specifically, first, for each data source (data source name 602), the relevant data source identifying unit 1700 determines, on the basis of the information identified in step 1707, a business process relevance value 701 between a “corresponding business process (business process name 502)” identified in step 1710 and a business process corresponding to a primary data source (business process name corresponding to the primary data source). Then, in the example of FIG. 8, the relevant data source identifying unit 1700 calculates, for each data source (data source name 602), an importance score 801 on the basis of the determined business process relevance value 701 and one or both of an index related to the update frequency 604 or an index related to the reference frequency 605 identified in step 1710.

In the examples shown in FIGS. 3, 4, 7, and 8, when the KPI name 302 received from the user operation system 204 is “cost,” the search keywords identified are “facility data” and “maintenance data.” Accordingly, the primary data source names (primary data source identification information 169) are “facility data 1,” “facility data 2,” and “maintenance data 1.” Further, the business process names corresponding to the primary data sources (primary data source corresponding business process identification information 159) are “operation” and “maintenance.” Then, the business process relevance value 701 associated with the respective business processes are any of the business process relevance values 701 included in the “operation” process relevance 711 and any of the business process relevance values 701 included in “maintenance” process relevance 712 both shown in FIG. 7. An example of the data source “predictive data 1” is as follows. According to the data source characteristic table 600 (data characteristic information) shown in FIG. 6, the business process name 502 corresponding to the data source “predictive data 1” is “implementation planning,” the index related to the update frequency 604 corresponding to the data source “predictive data 1” is “0.80,” and the index related to the reference frequency 605 corresponding to the data source “predictive data 1” is “0.90.” Further, according to the business process relevance table 700 shown in FIG. 7, for “implementation planning,” which is the business process name 502 corresponding to the data source “predictive data 1,” the business process relevance value 701 included in the “operation” process relevance 711 is “0.80,” and the business process relevance value 701 included in the “maintenance” process relevance 712 is “0.70.”

As described above, as shown in FIG. 8, an index “0.80” related to the update frequency 604, an index “0.90” related to the reference frequency 605, a business process relevance value 701 “0.80” included in the “operation” process relevance 711, and a business process relevance value 701 “0.70” included in the “maintenance” process relevance 712 are associated with the data source “predictive data 1.”

In the example of FIG. 8, the relevant data source identifying unit 1700 calculates, for each data source, a sum of an index related to the update frequency 604, an index related to the reference frequency 605, a business process relevance value 701 included in the “operation” process relevance 711, and a business process relevance value 701 included in the “maintenance” process relevance 712, and determines the sum as an importance score 801. For example, for the data source “predictive data 1,” a value “3.20” is determined as the importance score 801 for a performance indicator (KPI) “cost,” as a sum of “0.80,” “0.90,” “0.80,” and “0.70.” The method for calculating the importance score 801 is not limited to the above-described summation, and an arbitrary function may be used to calculate the importance score 801.

As described above, when an index related to the update frequency 604 or an index related to the reference frequency 605 is reflected in the importance score 801, it can be understood that information similar to an importance of each data source over a most recent predetermined period or over some period is reflected in the importance score 801 for each data source.

The relevant data source identifying unit 1700 may store the importance scores 801 determined for respective data sources (data source names 602) in the importance score table 800 (importance score information).

In step 1712 of FIG. 17, the relevant data source identifying unit 1700 identifies a relevant data source for the KPI name 302 received from the user operation system 204 on the basis of the importance scores 801 for the respective data sources identified in step 1711.

In identifying relevant data sources, as in the example of FIG. 8, the relevant data source identifying unit 1700 may identify, as relevant data sources, a prescribed number of data sources (five in the example of FIG. 8) having higher rankings of the importance scores 801. Alternatively, the relevant data source identifying unit 1700 may identify, as relevant data sources, data sources whose importance scores 801 are equal to or larger than, or larger than, a prescribed threshold. Alternatively, relevant data sources may be identified on the basis of another criterion with respect to the importance scores 801.

Data source names 602 of the identified relevant data sources may be referred to as relevant data source names 802 (relevant data source identification information). As shown in FIG. 8, various pieces of information related to the identified relevant data sources may be referred to as relevant data source related information 803.

After identification of the relevant data sources and the like is completed, the relevant data source identifying unit 1700 notifies the relevant data source identification overall control unit 1500 to that effect. Thereafter, the control returns to step 1701.

### 4.1.4. Functional Configuration, Processing, and Information Related to Display Control of Relevant Data Source Related Information (FIG. 18)

This section describes the functional configuration of the system 101, processing by the system, and information handled by the system when presenting relevant data source related information 803 identified by the relevant data source identifying unit 1700 to the user operation system 204. A functional unit mainly responsible for performing the processing described in this section is a relevant data source related information display control unit 1800.

With the functional configuration, processing, and information which will be described below, information indicating which data sources are relevant data sources related to a performance indicator (KPI) for consideration by a user can be presented to the user operating the user operation system 204. Further, not only information for identifying relevant data sources but also information related to grounds or circumstances under which a specific data source is identified as a relevant data source among data sources included in the data source group 211 (see FIG. 2) may be presented to the user operating the user operation system 204. Accordingly, the user can accurately determine positions of respective relevant data sources in consideration of the performance indicator (KPI).

FIG. 18 is a flowchart for illustrating processing by the relevant data source related information display control unit 1800.

In step 1801 of FIG. 18, the relevant data source related information display control unit 1800 determines whether a request to present relevant data source related information 803 to the user operation system 204 has been received from the relevant data source identification overall control unit 1500. The instruction (request) may be issued near the beginning of step 1504 of FIG. 15. If the determination result in step 1801 is affirmative, the control proceeds to step 1802. If the determination result in step 1801 is negative, step 1801 is repeated.

In step 1802 of FIG. 18, the relevant data source related information display control unit 1800 obtains various pieces of information related to each of the relevant data sources identified by the relevant data source identifying unit 1700. In the examples of FIG. 6 or FIG. 8, the relevant data source related information display control unit 1800 may acquire information included in records corresponding to the respective relevant data sources from one or both of the data source characteristic table 600 (data source characteristic information) and the importance score table 800 (importance score information). The various pieces of information related to the relevant data sources obtained by the relevant data source related information display control unit 1800 may include, for example, some or all of a data source name 602 (relevant data source name 802), a corresponding business process name 502, an importance score 801, an index related to the update frequency 604, and an index related to the reference frequency 605.

Further, in step 1802, the relevant data source related information display control unit 1800 may also obtain a primary data source (primary data source name) identified in step 1704 of FIG. 17 or a business process corresponding to the primary data source (business process name corresponding to the primary data source) identified in step 1706 of FIG. 17. The relevant data source related information display control unit 1800 may obtain the above information from information stored by the relevant data source identifying unit 1700, or may obtain the above information by referring to various tables.

In step 1803 of FIG. 18, the relevant data source related information display control unit 1800 may generate supplementary information for each of relevant data sources using the various pieces of information obtained in step 1802. The supplementary information may indicate grounds or circumstances for which each relevant data source is identified as a relevant data source. For example, when a relevant data source is a primary data source identified in step 1706 of FIG. 17, the relevant data source related information display control unit 1800 may generate supplementary information indicating that fact. Further, for example, when a business process corresponding to a relevant data source is the same as a business process corresponding to a primary data source, the relevant data source related information display control unit 1800 may generate supplementary information indicating that fact. Further, for example, when a relevant data source is identified as a relevant data source mainly because the relevant data source has a notable characteristic related to certain characteristic information, the relevant data source related information display control unit 1800 may generate supplementary information indicating that fact. Specifically, when an index related to the update frequency 604 or an index related to the reference frequency 605 for a relevant data source is equal to or larger than, or larger than, a prescribed threshold, that fact may be generated as supplementary information for the relevant data source.

In step 1804 of FIG. 18, the relevant data source related information display control unit 1800 determines which type of data source identification graphical user interface (data source identification GUI) is being presented by the KPI name receiving unit 1600 (performance indicator identification information receiving unit) in order to receive a KPI name 302 (performance indicator identification information) from the user operation system 204. If the determination result in step 1804 is a form input type data source identification graphical user interface 1000 as shown in FIG. 10, the control proceeds to step 1805. If the determination result in step 1804 is a chat type data source identification graphical user interface 1100 as shown in FIG. 11, the control proceeds to step 1806.

In step 1805 of FIG. 18, the relevant data source related information display control unit 1800 presents, to the user operation system 204, various pieces of information captured (acquired) or generated in step 1802 or step 1803 via the form input type data source identification graphical user interface 1000 as shown in FIG. 10. In the example of FIG. 10, the relevant data source related information display control unit 1800 may control display such that part or all of a data source name 602 (relevant data source name 802), a business process name 502, an importance score 801, and supplementary information (generated in step 1803) are displayed as respective records of the relevant data source related information table 1020 at a lower portion of the form input type data source identification graphical user interface 1000 shown in FIG. 10. The user operation system 204 may also be involved in the display control. After step 1805, the control proceeds to step 1808.

In step 1806 of FIG. 18, the relevant data source related information display control unit 1800 generates or acquires a natural language explanatory text for display in the system output field 1150 on a right side of the chat type data source identification graphical user interface 1100 as shown in FIG. 11, by using various pieces of information captured (acquired) or generated in step 1802 or step 1803. At the time, the relevant data source related information display control unit 1800 may input the various pieces of information captured (acquired) or generated in step 1802 or step 1803 to a trained model and acquire, as output from the trained model, natural language explanatory text. Alternatively, the relevant data source related information display control unit 1800 may generate natural language explanatory text on the basis of certain rules by using the various pieces of information captured (acquired) or generated in step 1802 or step 1803. In step 1807 of FIG. 18, the relevant data source related information display control unit 1800 presents information indicating the natural-language explanatory text generated or acquired in step 1806 to the user operation system 204 via the chat type data source identification graphical user interface 1100 as shown in FIG. 11. In the example of FIG. 11, the relevant data source related information display control unit 1800 may control display such that the natural-language explanatory text generated or acquired in step 1806 is displayed in the system output field 1150 provided on a right side of the chat type data source identification graphical user interface 1100 shown in FIG. 11. The user operation system 204 may also be involved in the display control.

In the example of FIG. 11, a natural language explanatory text to be displayed first indicates a sentence stating “Data sources with high relevance are displayed in descending order of importance scores, as follows.” Thereafter, for each of the relevant data sources, a sentence mainly generated on the basis of the relevant data source related information 803 is displayed.

For example, for a data source “facility data 1” which is ranked first according to the importance score 801 in FIG. 8, a sentence stating “Facility data 1: importance score 3.40. This data source is set as a primary data source for the KPI “cost”.” is displayed. In this manner, supplementary information indicating that the data source “facility data 1” is a primary data source is presented.

Further, for a data source “predictive data 1” which is ranked second in descending order of the importance score 801 in FIG. 8, a sentence stating “Predictive data 1: importance score 3.20. The reference frequency is high, and there is a high possibility that up-to-date data has been collected.” is displayed. In this manner, supplementary information indicating that the data source “predictive data 1” has an index related to the reference frequency 605 that is equal to or larger than, or larger than, the prescribed threshold (though the data source is not a primary data source) is presented.

Further, for a data source “operation data 1,” which is ranked fifth according to the importance score 801 in FIG. 8, a sentence stating “Operating data 1: importance score 2.95. This data source is set as a data source for the business process “operation”.” is displayed. In this manner, supplementary information indicating that the data source “operation data 1” is a data source corresponding to the business process “operation,” which is a business process corresponding to a primary data source (though the data source is not a primary data source) is presented.

After step 1807, the control proceeds to step 1808.

In step 1808 of FIG. 18, the relevant data source related information display control unit 1800 may receive, via the user operation system 204, a request from a user who has viewed the relevant data source related information 803 presented in step 1805 or step 1807 to obtain the related data source itself.

In the form input type data source identification graphical user interface 1000 shown in FIG. 10, in response to a click or tap operation using an input device of the user operation system 204 (for example, a mouse or a touch panel) performed on a data source name 602 (relevant data source name 802) included in each record of the relevant data source related information table 1020 displayed in a lower portion of FIG. 10, a request to acquire the relevant data source itself may be transmitted from the user operation system 204 to the system 100.

In the chat type data source identification graphical user interface 1100 shown in FIG. 11, in response to a click or tap operation using an input device of the user operation system 204 (for example, a mouse or a touch panel) performed on a data source name 602 (relevant data source name 802) included in the explanatory text displayed in the system output field 1150 on a right side of FIG. 11, a request to acquire the relevant data source itself may be transmitted from the user operation system 204 to the system 100.

When the request to acquire the relevant data source itself is transmitted to the system 100, the relevant data source related information display control unit 1800 (or another functional unit of the system 100) may perform control such that the content of the designated relevant data source among the data source group 211 (see FIG. 2) is provided to the user operation system 204.

After step 1808 (or after step 1808 is skipped when no request to acquire the relevant data source is made), the relevant data source related information display control unit 1800 notifies the relevant data source identification overall control unit 1500 that a series of processes related to relevant data source display control has been completed. Thereafter, the control returns to step 1801.

### 4.1.5. Functional Configuration, Processing, and Information Related to Update of Primary Data Source Condition (FIG. 19)

This section describes the functional configuration of the system 101, processing by the system, and information handled by the system when search keywords (primary data source conditions) corresponding to a performance indicator (KPI) are updated in association with identification of relevant data sources for the performance indicator (KPI). The functional unit mainly responsible for performing the processing described in this section is the primary data source condition updating unit 1900.

With the functional configuration, processing, and information which will be described below, knowledge regarding an association between a performance indicator (KPI) and relevant data sources, which has been identified using not only the KPI analysis table 300 (performance indicator analysis information) but also the data source characteristic table 600 (data source characteristic information) and the business process relevance table 700 (business process relevance information), can be reflected in the KPI analysis table 300. Accordingly, it is expected that accuracy of identification of relevant data sources for a performance indicator (KPI) is improved, and that changes in circumstances over time are also reflected in processing for identifying relevant data sources for the performance indicator (KPI).

In addition, a history of changes in time series in contents of the KPI analysis table 300 can be recorded in a primary data source condition version management table 400 (primary data source condition version management information). Accordingly, information that can later be used for analysis of changes in time series related to the performance indicator (KPI) can be secured.

FIG. 19 is a flowchart for illustrating processing by the primary data source condition updating unit 1900.

In step 1901 of FIG. 19, the primary data source condition updating unit 1900 determines whether a request to update search keywords for a performance indicator (KPI) has been received from the relevant data source identification overall control unit 1500, the request being issued in response to identification of relevant data sources for the performance indicator (KPI) by the relevant data source identifying unit 1700. The instruction (request) may be issued near the beginning of step 1505 of FIG. 15. When the determination result in step 1901 is affirmative, the control proceeds to step 1902. If the determination result in step 1901 is negative, step 1901 is repeated.

In step 1902 in FIG. 19, the primary data source condition updating unit 1900 further selects, on the basis of prescribed criteria, a relevant data source from one or more relevant data sources identified in step 1712. For example, while five relevant data sources are identified in step 1712, two of the five relevant data sources may be further selected in step 1902. (The number of relevant data sources to be selected may be arbitrarily determined.) The criteria used at the time may be the rankings of the importance score 801. In the example of FIG. 8, the data source “facility data 1” ranked first in the importance score 801, and the data source “predictive data 1” ranked second in the importance score 801 may be selected in step 1902.

The selection of data sources in step 1902 is not limited to the method described above, and other methods may be used. For example, relevant data sources whose importance scores 801 are equal to or larger than, or larger than, the prescribed threshold may be selected in step 1902. Alternatively, regardless of the selection of relevant data sources in step 1712, the selection of data sources in step 1902 may be performed on the basis of the importance scores 801 of the respective data sources as shown in FIG. 8.

In step 1903 in FIG. 19, the primary data source condition updating unit 1900 generates respective new search keywords corresponding to each of the relevant data sources (or data sources) selected in step 1902. For example, when the data source “facility data 1” and the data source “predictive data 1” are selected in step 1902, the primary data source condition updating unit 1900 may generate, in step 1903, “facility data” and “predictive data” as new search keywords on the basis of the data source names 602 (relevant data source names 802).

In step 1904 in FIG. 19, the primary data source condition updating unit 1900 compares the new search keywords generated in step 1903 with the search keywords registered in the KPI analysis table 300 at that time point. For example, as shown in FIG. 3, while the search keywords registered in the KPI analysis table 300 for the performance indicator (KPI) “cost” at that time point are “facility data” and “maintenance data” if the new search keywords generated in step 1903 for the performance indicator (KPI) “cost” are “facility data” and “predictive data,” the two sets do not completely match.

In step 1904, the primary data source condition updating unit 1900 determines whether the contents of the KPI analysis table 300 would be changed if the new search keywords generated in step 1903 were reflected in the KPI analysis table 300. If the determination result in step 1904 is affirmative, the control proceeds to step 1905. If the determination result in step 1904 is negative, the fact that updating of the search keywords is unnecessary is notified to the relevant data source identification overall control unit 1500, and the control returns to step 1901.

In the above example, when the new search keywords generated in step 1903 are reflected in the record of the KPI analysis table 300 for the performance indicator (KPI) “cost,” the search keyword “maintenance data” which existed before the reflection is deleted, and the search keyword “predictive data” is newly set. That is, in this case, the determination result in step 1904 is affirmative.

In step 1905 of FIG. 19, the primary data source condition updating unit 1900 sets (updates), in a record of the KPI analysis table 300 corresponding to the KPI name 302 (performance indicator identification information) received from the user operation system 204, the search keywords generated in step 1903. At the time, for search keywords whose contents are not changed before and after step 1905, the setting (updating) processing may be omitted. For example, when the search keywords before setting (updating) for the performance indicator (KPI) “cost” are “facility data” and “maintenance data,” and the search keywords after setting (updating) are “facility data” and “predictive data,” the setting (updating) processing is not performed for “facility data,” and the search keyword “predictive data” may be set (updated) in place of “maintenance data.”

In step 1906 of FIG. 19, the primary data source condition updating unit 1900 registers, in the primary data source condition version management table 400, a new record based on the information contained in the record of the KPI analysis table 300 set (updated) in step 1905. For example, in the example of FIG. 4, when the search keywords for the performance indicator (KPI) “cost” become “facility data” and “predictive data,” the primary data source condition updating unit 1900 registers a new record, such as a record in FIG. 4 in which a value of the version 401 is “2.0.”

After step 1906, the primary data source condition updating unit 1900 notifies the relevant data source identification overall control unit 1500 that a series of processes related to updating of the search keywords has been completed. Thereafter, the control returns to step 1901.

### 4.2. Functional Configuration, Processing, and Information Related to Collection of Access Histories (FIG. 20)

This section describes the functional configuration of the system 101 (or the data storage system 201), processing performed by the system, and information handled by the system when collecting access histories to respective data sources in association with implementation (execution) of respective business processes. The functional unit mainly responsible for performing the processing described in this section is an access history collection unit 2000. The access history collection unit 2000 may be a functional unit within the data storage system 201 or may be a functional unit within the system 100.

With the functional configuration, processing, and information which will be described below, individual access logs 903 can be recorded in a manner associated with a timestamp 901, an access source 902, and a business process name 502 (business process identification information). With such records, calculation of the business process relevance value 701 between business processes by a business process relevance updating unit 2100, which will be described later, can be appropriately performed.

In addition, as data access logs stored in the data access log table 900 (data access log information) are accumulated, information related to characteristics of each data source managed in the data source characteristic table 600 (data source characteristic information) may be updated. For example, an index related to the update frequency 604 and an index related to the reference frequency 605 may be updated. In this manner, over time, information related to characteristics of each data source can also be updated in a timely manner via access histories.

FIG. 20 is a flowchart for illustrating processing by the access history collection unit 2000.

In step 2001 of FIG. 20, the access history collection unit 2000 determines whether there has been an access to any of the data sources among the data source group 211 (see FIG. 2). The access source 902 to the data source may be any of the data analyst operation systems 202 (see FIG. 2) operated by any of data analysts, or any of the data analysis systems 203 (see FIG. 2).

If the determination result in step 2001 is affirmative, the access history collection unit 2000 acquires, with respect to the detected access, a timestamp 901, information identifying the access source 902, and an access log 903. The forms of the timestamp 901, the information identifying the access source 902, and the access log 903 may be as shown in FIG. 9. Thereafter, the control proceeds to step 2002. If the determination result in step 2001 is negative, step 2001 is repeated.

In step 2002 of FIG. 20, the access history collection unit 2000 identifies a data source name 602 (data source identification information) of the data source that is the access target, with respect to the access detected in step 2001. If the access log 903 has a form as shown in FIG. 9, the access log 903 includes the data source name 602 itself or a character string or the like associated with the data source name 602. Accordingly, the access history collection unit 2000 can identify the data source name 602 on the basis of the access log 903. Alternatively, the access history collection unit 2000 may identify the data source name 602 by another method.

In step 2003 of FIG. 20, the access history collection unit 2000 estimates (identifies), with respect to the access detected in step 2001, a business process name 502 (business process identification information) of a business process attributable to the access. For example, the access history collection unit 2000 may estimate (identify) the business process name 502 on the basis of the data source name 602 identified in step 2002 and information indicating an association between the data source name 602 and the business process name 502 shown in the data source characteristic table 600. Alternatively, the access history collection unit 2000 may estimate (identify) a business process name 502 of a business process attributable to the access by another method.

In step 2004 of FIG. 20, the access history collection unit 2000 registers, in the data access log table 900 (data access log information) as shown in FIG. 9, a new record including the timestamp 901 acquired in step 2001, the information identifying the access source 902, the access log 903, and the business process name 502 estimated (identified) in step 2003.

In step 2005 of FIG. 20, the access history collection unit 2000 may update, as required, in a record of the data source characteristic table 600 corresponding to the data source name 602 identified in step 2002, a last update date and time 603, an index related to the update frequency 604, and an index related to the reference frequency 605. When updating the index related to the update frequency 604 and the index related to the reference frequency 605, the access history collection unit 2000 may refer to a plurality of records in the data access log table 900 having relatively recent timestamps 901. After step 2005, the control returns to step 2001.

It should be noted that step 2005 does not necessarily need to be executed every time access is detected in step 2001. For example, step 2005 may be executed each time the number of times access to a data source corresponding to the same data source name 602 is detected in step 2001 reaches a prescribed number. Alternatively, step 2005 may be executed, separately from control of steps 2001 to 2004, each time a prescribed period of time elapses, for some or all of the data sources included in the data source group 211.

### 4.3. Functional Configuration, Processing, and Information Related to Update of Business Process Relevance (FIG. 21)

This section describes the functional configuration of the system 101, processing by the system, and information handled by the system when updating the business process relevance value 701 between business processes (business process relevance value 701 corresponding to pairs of business processes) on the basis of access histories to respective data sources. The functional unit mainly responsible for performing the processing described in this section is the business process relevance updating unit 2100.

With the functional configuration, processing, and information which will be described below, even when information explicitly indicating relationships (relevance) between business processes is scarce, combinations of business processes implemented (executed) during the same time period from the same access source 902 can be estimated (identified), and the business process relevance value 701 corresponding to pairs of business processes can be determined on the basis of results of the estimation (identification). Accordingly, the business process relevance value 701 can be determined in various situations in which respective business processes are implemented (executed).

In addition, when combinations of business processes that are implemented (executed) during the same time period from the same access source 902 change over time, such changes are reflected in the business process relevance value 701. In this manner, the business process relevance value 701 that reflects changes in circumstances can be used.

FIG. 21 is a flowchart for illustrating processing by the business process relevance updating unit 2100.

In step 2101 of FIG. 21, the business process relevance updating unit 2100 determines whether a timing to update the business process relevance value 701 corresponding to a pair of business processes managed in the business process relevance table 700 (business process relevance information), as shown in FIG. 7 has arrived. The business process relevance updating unit 2100 may treat the timing to update the business process relevance value 701 as arriving at regular time intervals. Alternatively, the business process relevance updating unit 2100 may determine arrival of the timing to update the business process relevance value 701 on the basis of other criteria. If the determination result in step 2101 is affirmative, the control proceeds to step 2102. If the determination result in step 2101 is negative, step 2101 is repeated.

In step 2102 of FIG. 21, the business process relevance updating unit 2100 identifies, on the basis of prescribed criteria, a portion (a partial record group) to be used as an information source for calculating a business process relevance value 701 from among a group of records included in the data access log table 900 (data access log information). For example, the business process relevance updating unit 2100 may identify, as an information source for calculating a business process relevance value 701, a set of records (an information source record group) having timestamps 901 that fall within a prescribed length of time (for example, a prescribed number of days) immediately preceding the time at which step 2102 is executed.

In step 2103 of FIG. 21, the business process relevance updating unit 2100 distributes each of the records of the data access log table 900 included in the information source record group identified in step 2102 into one of subsets (divided logs) (that is, to divide the access logs). Here, the subsets (divided logs) may be partitioned, for example, for each access source 902 and for each time period to which the timestamp 901 belongs.

The length of the time period to which the timestamp 901 belongs when defining the subset (divided log) may be determined according to the access source 902. For example, the length of the time period (time interval T_s) defined for the data analysis system 203, with relatively less manual intervention, may be set shorter than the length (time interval T_u) defined for the data analyst operation system 202. In the example of FIG. 9, the time interval T_u is set to 120 seconds, whereas the time interval T_s is set to 20 seconds. The reason for this setting is that the data analysis system 203, which involves relatively less manual intervention, tends to have a higher number or volume of accesses to data sources per unit time. In other words, the number of records of the data access log table 900 included in each subset (divided log) may be leveled. Leveling the number of records in the data access log table 900 within each subset (divided log) is expected to make the count numbers handled in steps 2107 and 2109 more appropriate as the basis for calculating the business process relevance value 701.

Alternatively, instead of forming subsets (divided logs) based on the time interval T_u or time interval T_s as described above, a subset (divided log) may be formed for every prescribed number of records in the data access log table 900, consisting of records with the same access source 902 and timestamps 901 that are close to each other.

In step 2104 of FIG. 21, the business process relevance updating unit 2100 resets a count value for each pair of business processes managed by the business process relevance table 700 as shown in FIG. 7. The count value may be a variable internally used by the business process relevance updating unit 2100. The reset value may be, for example, zero. The count value is used to count, for each pair of business processes, the number of subsets (divided logs) in which it is observed that the pair of business processes are both implemented (executed) with the same access source 902 and with timestamps 901 that are close to each other.

In step 2105 of FIG. 21, the business process relevance updating unit 2100 selects one of the subsets (divided logs) set in step 2103.

In step 2106 of FIG. 21, the business process relevance updating unit 2100 extracts (identifies) business process names 502 recorded in the record(s) of the data access log table 900 included in the subset (divided log) selected in the immediately preceding step 2105. In the example of FIG. 9, a divided log α (surrounded by a dotted line in FIG. 9), which indicates an access history during the period from 9:00:00 on Sep. 1, 2024 to immediately before 9:02:00 on the same day (120 seconds) by the data analyst operation system 202 operated by data analyst A, includes three records. From the business process names 502 of these three records, the business process “operation” and the business process “maintenance” are extracted (identified). Further, a divided log β (surrounded by a dash-dot line in FIG. 9), which indicates an access history during the period from 9:01:20 on Sep. 1, 2024 to immediately before 9:01:40 on the same day (20 seconds) by data analysis system B, includes five records. From the business process names 502 of these five records, the business process “operation,” the business process “maintenance,” and the business process “implementation planning” are extracted (identified). Further, a divided log γ (surrounded by a thick solid line in FIG. 9), which indicates an access history during the period from 9:02:00 on Sep. 1, 2024 to immediately before 9:04:00 on the same day (120 seconds) by the data analyst operation system 202 operated by data analyst A, includes two records. From the business process names 502 of these two records, the business process “operation” and the business process “supply-demand management” are extracted (identified).

In step 2107 of FIG. 21, the business process relevance updating unit 2100 updates the count for each pair of business process names 502 included in the set of business process names 502 (business process identification information) extracted (identified) in the immediately preceding step 2106. For example, the method for updating the count may be such that the count is incremented by one. For example, in the case of the divided log β in FIG. 9, since the business process “operation,” the business process “maintenance,” and the business process “implementation planning” are extracted (identified) in step 2106, in step 2107, the count corresponding to each of the pairs “operation” and “maintenance,” “operation” and “implementation planning,” and “maintenance” and “implementation planning” may be incremented by one.

Alternatively, the method for updating the count may depend on the respective situations of the records within the subset (divided log). That is, the increment need not be one and may be variable depending on the conditions.

In step 2108 of FIG. 21, the business process relevance updating unit 2100 determines whether all of the subsets (divided logs) set in step 2103 have already been selected in step 2105. If the determination result in step 2108 is affirmative, the control proceeds to step 2109. If the determination result in step 2108 is negative, the control returns to step 2105, and a subset (divided log) that has not yet been selected is newly selected.

In step 2109 of FIG. 21, the business process relevance updating unit 2100 calculates a business process relevance value 701 for each pair of business processes managed by the business process relevance table 700 as shown in FIG. 7, on the basis of the count value corresponding to the pair. For example, the business process relevance updating unit 2100 may define a quotient obtained by dividing the count value by a prescribed constant as the business process relevance value 701. When the calculated quotient exceeds an upper limit value of 1.0 for the business process relevance value 701, the business process relevance value 701 may be set to 1.0. Alternatively, the method for calculating the business process relevance value 701 on the basis of the count value is not limited to the above method, and another method may be used. The business process relevance updating unit 2100 updates the business process relevance table 700 using the calculated value of the business process relevance value 701. After step 2109, the control returns to step 2101.

### 4.4. Functional Configuration, Processing, and Information Related to Setting of KPI Analysis Table (FIG. 22)

This section describes the functional configuration of the system 101, processing by the system, and information handled by the system when information to be set in the KPI analysis table 300 (performance indicator analysis information) is set by a user via the user operation system 204. A functional unit mainly responsible for performing the processing described in this section is the KPI analysis table setting receiving unit 2200 (performance indicator analysis information setting receiving unit).

With the functional configuration, processing, and information which will be described below, the system 100 can receive, in response to an instruction from the user, registration of a new KPI name 302 (performance indicator identification information) or setting of an association between a KPI name 302 and one or more search keywords (primary data source conditions). As a result, performance indicators (KPIs) that the user wishes to handle can be arbitrarily set, and knowledge or assumptions of the user regarding data sources regarded as relevant to the performance indicator (KPI) can be utilized in the system 100 as search keywords.

FIG. 22 is a flowchart for illustrating processing by the KPI analysis table setting receiving unit 2200.

In step 2201 of FIG. 22, the KPI analysis table setting receiving unit 2200 determines whether a trigger has occurred for the user, via the user operation system 204, to set information in the KPI analysis table 300. For example, when the user makes an explicit request to the system 100 for setting of the KPI analysis table 300 via the user operation system 204, the determination result in step 2201 may be affirmative. If the determination result in step 2201 is affirmative, the control proceeds to step 2202. If the determination result in step 2201 is negative, step 2201 is repeated.

In step 2202 of FIG. 22, the KPI analysis table setting receiving unit 2200 controls the KPI analysis table setting graphical user interface 1200 as shown in FIG. 12 (performance indicator analysis information setting graphical user interface (GUI)) to be displayed in the user operation system 204. The user operation system 204 may also be involved in the display control. At the time of display of the KPI analysis table setting graphical user interface 1200 as shown in FIG. 12 in step 2202, a KPI analysis table status 1220 (performance indicator information status), which indicates part or all of the information included in the KPI analysis table 300 at the time point (before updating), may be displayed in a lower portion of FIG. 12.

The user may input a KPI name 302 into a KPI name input field 1211 (performance indicator identification information input field) and inputs search keywords into respective ones of one or more search keyword input fields (primary data source condition input fields), by using an input device of the user operation system 204 (for example, a keyboard or a touch panel).

When a search keyword is input into at least one of the search keyword input fields, search keywords need not be input into the other search keyword input fields.

Alternatively, instead of or in addition to the KPI name input field 1211, the search keyword 1 input field 1231 (primary data source condition 1 input field), and the search keyword 2 input field 1232 (primary data source condition 2 input field) shown in FIG. 12, selection of options by means of a pull-down menu may be enabled.

When the user clicks or taps a KPI analysis table setting icon 1215 (performance indicator analysis information setting icon) by using an input device of the user operation system 204 (for example, a mouse or a touch panel), information input into the KPI name input field 1211, the search keyword 1 input field 1231 (primary data source condition 1 input field), and the search keyword 2 input field 1232 (primary data source condition 2 input field) is transmitted to the system 100. In step 2203 of FIG. 22, the KPI analysis table setting receiving unit 2200 recognizes the information input into the KPI name input field 1211, the search keyword 1 input field 1231 (primary data source condition 1 input field), and the search keyword 2 input field 1232 (primary data source condition 2 input field). That is, the KPI analysis table setting receiving unit 2200 recognizes the KPI name 302 and one or more search keywords input by the user.

In step 2204 of FIG. 22, the performance indicator (KPI) analysis table setting receiving unit 2200 performs control so that a record including the performance indicator (KPI) name 302 recognized in step 2203 and one or more search keywords exists in the performance indicator (KPI) analysis table 300. If a record related to the KPI name 302 recognized in step 2203 does not exist in the KPI analysis table 300 at that time, the KPI analysis table setting receiving unit 2200 registers (sets), in the KPI analysis table 300, a new record related to the KPI name 302 recognized in step 2203. In this new record, one or more search keywords recognized in step 2203 are also set.

If a record related to the KPI name 302 recognized in step 2203 exists in the KPI analysis table 300 at the time point, the KPI analysis table setting receiving unit 2200 sets, in the existing record in the KPI analysis table 300, one or more search keywords recognized in step 2203 (that is, to update the search keywords).

In step 2205 of FIG. 22, the KPI analysis table setting receiving unit 2200 may control display such that the KPI analysis table status 1220 indicating part or all of information contained in the KPI analysis table 300 that reflects the setting (updating) performed in step 2204 is displayed in a lower portion of the KPI analysis table setting graphical user interface 1200 as illustrated in FIG. 12. The user operation system 204 may be involved in the display control. Further, at the time, as illustrated in FIG. 12, a portion of record changed by the new setting may be highlighted by a thick border as indicated by a changed record highlighting display 1221 or by coloring the record portion.

In step 2206 of FIG. 22, the KPI analysis table setting receiving unit 2200 registers, in the primary data source condition version management table 400 (primary data source condition version management information), a record representing the setting (updating) of the KPI analysis table 300 performed in step 2204. After step 2206, the control returns to step 2201.

### 4.5. Functional Configuration, Processing, and Information Related to Registration of Business Processes (FIG. 23)

This section describes the functional configuration of the system 101, processing by the system, and information handled by the system when information to be set in the business process list table 500 (business process list information) is set by the user via the user operation system 204.

The functional unit mainly responsible for performing the processing described in this section is the business process registration receiving unit 2300.

With the functional configuration, processing, and information which will be described below, the system 100 can recognize any variations in types of business processes that access each data source.

FIG. 23 is a flowchart for illustrating processing by the business process registration receiving unit 2300.

In step 2301 of FIG. 23, the business process registration receiving unit 2300 determines whether a trigger for the user to set information in the business process list table 500 via the user operation system 204 has occurred. For example, when the user makes an explicit request to the system 100, via the user operation system 204, to set the business process list table 500, the determination result in step 2301 may be affirmative. If the determination result in step 2301 is affirmative, the control proceeds to step 2302. If the determination result in step 2301 is negative, step 2301 is repeated.

In step 2302 of FIG. 23, the business process registration receiving unit 2300 controls the business process registration graphical user interface 1300 (business process registration GUI), as shown in FIG. 13, to be displayed in the user operation system 204. The user operation system 204 may also be involved in the display control. At the time of displaying the business process registration graphical user interface 1300 as shown in FIG. 13 in step 2302, the business process list table status 1320 (business process list information status), which indicates part or all of the information included in the business process list table 500 at the time point (before updating), may be displayed in a lower portion of FIG. 13.

The user inputs a business process name 502 (business process identification information) into a business process name input field 1312 (business process identification information input field) by using an input device included in the user operation system 204 (for example, a keyboard or a touch panel).

When the user clicks, by using an input device included in the user operation system 204 (for example, a mouse or a touch panel), a business process list table setting icon 1315 (business process list information setting icon), the information input into the business process name input field 1312 is transmitted to the system 100.

In step 2303 of FIG. 23, the business process registration receiving unit 2300 recognizes the information input into the business process name input field 1312 (business process identification information input field). That is, the business process registration receiving unit 2300 recognizes the business process name 502 input by the user.

In step 2304 of FIG. 23, the business process registration receiving unit 2300 performs control such that a record including the business process name 502 recognized in step 2303 comes to exist in the business process list table 500. In this case, the business process registration receiving unit 2300 newly registers a record including the business process name 502 previously not included in the business process list table 500 at the time point (before updating).

In step 2305 of FIG. 23, the business process registration receiving unit 2300 may control the business process list table status 1320, which indicates part or all of the information included in the business process list table 500 that reflects the setting (updating) in step 2304, to be displayed in a lower portion of the business process registration graphical user interface 1300 as shown in FIG. 13. The user operation system 204 may also be involved in the display control. At the time, as shown in FIG. 13, a portion of the record changed by the new setting may be highlighted by a thick border as indicated by the changed record highlighting display 1321, or by coloring the record portion.

After step 2305, the control returns to step 2301.

In the example of the processing shown in FIG. 23, a record including a business process name 502 is newly registered in the business process list table 500. In addition to this, deletion of a record including a business process name 502 already registered in the business process list table 500 may be permitted. Further, in a record including a business process name 502 already registered in the business process list table 500, a change of the name of the business process name 502 may be permitted.

### 4.6. Functional Configuration, Processing, and Information Related to Registration of Relationship between Data Sources and Business Processes (FIG. 24)

This section describes the functional configuration of the system 101, processing by the system, and information handled by the system when setting (changing) information indicating associations between data source names 602 (data source identification information) and business process names 502 (business process identification information), which are managed by the data source characteristic table 600 (data source characteristic information). The functional unit mainly responsible for performing the processing described in this section is a data source-business process relationship registration receiving unit 2400.

With the functional configuration, processing, and information described below, knowledge and assumptions of the user regarding associations indicating respective data sources accessed when respective business processes are implemented (executed) can be utilized in the system 100 as setting information managed by the data source characteristic table 600.

FIG. 24 is a flowchart for illustrating processing by the data source-business process relationship registration receiving unit 2400.

In step 2401 of FIG. 24, the data source-business process relationship registration receiving unit 2400 determines whether a trigger has occurred for the user to set information regarding associations between data source names 602 and business process names 502 in the data source characteristic table 600 via the user operation system 204. For example, when the user makes an explicit request to the system 100 for setting associations between data source names 602 and business process names 502 in the data source characteristic table 600 via the user operation system 204, the determination result in step 2401 may be affirmative. If the determination result in step 2401 is affirmative, the control proceeds to step 2402. If the determination result in step 2401 is negative, step 2401 is repeated.

In step 2402 of FIG. 24, the data source-business process relationship registration receiving unit 2400 controls the data source-business process relationship registration graphical user interface 1400 (data source-business process relationship registration GUI), as shown in FIG. 14, to be displayed in the user operation system 204.

The user operation system 204 may also be involved in the display control. When the data source-business process relationship registration graphical user interface 1400 as shown in FIG. 14 is displayed in step 2402, the data source characteristic table status 1420 (data source characteristic information status) indicating part or all of information included in the data source characteristic table 600 at the time point (before updating) may be displayed in a lower portion of FIG. 14.

The user selects a data source name 602 from options shown in the data source name selection pull-down menu 1413 (data source identification information selection pull-down menu) and selects a business process name 502 from options shown in the business process name selection pull-down menu 1412 (business process identification information pull-down menu), by using an input device of the user operation system 204 (for example, a mouse or a touch panel). Instead of the pull-down menus, a radio-button form may be used.

When it is desired to allow handling of a data source name 602 for which a corresponding record does not yet exist in the data source characteristic table 600 at the time point (before updating), the data source-business process relationship registration graphical user interface 1400 may include a data source name input field for receiving a new data source name. The user may input a new data source name 602 into the data source name input field by using an input device of the user operation system 204 (for example, a keyboard or a touch panel), instead of selecting the data source name 602 from the options shown in the data source name selection pull-down menu 1413.

Also, in the data source-business process relationship registration graphical user interface 1400 illustrated in FIG. 14, one business process name 502 is configured to be input; however, two or more business process names 502 may be input. When the user clicks the data source-business process relationship registration icon 1415 by using an input device of the user operation system 204 (for example, a mouse or a touch panel), information indicating selection contents in the data source name selection pull-down menu 1413 and the business process name selection pull-down menu 1412 is transmitted to the system 100. Alternatively, information input into the data source name input field and information indicating selection contents in the business process name selection pull-down menu 1412 are transmitted to the system 100.

In step 2403 of FIG. 24, the data source-business process relationship registration receiving unit 2400 recognizes information indicating the selection contents in the data source name selection pull-down menu 1413 and the business process name selection pull-down menu 1412. Alternatively, the data source-business process relationship registration receiving unit 2400 recognizes information input into the data source name input field and the information indicating the selection contents in the business process name selection pull-down menu 1412. That is, the data source-business process relationship registration receiving unit 2400 recognizes the data source name 602 and the business process name 502 selected or input by the user.

In step 2404 of FIG. 24, the data source-business process relationship registration receiving unit 2400 performs control such that a record including an association between the data source name 602 and the business process name 502 recognized in step 2403 exists in the data source characteristic table 600.

If, at the time point, a record corresponding to the data source name 602 recognized in step 2403 does not exist in the data source characteristic table 600, the data source-business process relationship registration receiving unit 2400 registers a new record corresponding to the data source name 602 recognized in step 2403 in the data source characteristic table 600. In this new record, the business process name 502 recognized in step 2403 is also set.

If, at the time point, a record corresponding to the data source name 602 recognized in step 2403 exists in the data source characteristic table 600, the data source-business process relationship registration receiving unit 2400 sets the business process name 502 recognized in step 2403 in the existing record in the data source characteristic table 600 (that is, to update the business process name corresponding to the data source name).

In step 2405 of FIG. 24, the data source-business process relationship registration receiving unit 2400 may control display such that part or all of the information included in the data source characteristic table 600 that reflects the setting (updating) in step 2404 is displayed in the data source characteristic table status 1420 at a lower part of the data source-business process relationship registration graphical user interface 1400 as shown in FIG. 14. The user operation system 204 may also be involved in this display control. Further, at the time, as shown in FIG. 14, a portion of the record changed by the new setting may be highlighted by a thick border as indicated by the changed record highlighting display 1421, or by coloring the record portion. After step 2405, the control returns to step 2401.

### 5. Others (Modifications)

The present disclosure is not limited to the embodiments described above and includes various modifications. Part of the configuration or processing of an embodiment may be replaced with configuration or processing of other conceivable embodiments. In addition, configuration or processing of other conceivable embodiments may be added to the configuration or processing of an embodiment.

The technical features described in the embodiments of the present disclosure and the modifications of the embodiments described above may be combined as appropriate, as long as no technical inconsistency arises.

What is claimed is:

1. A system comprising a relevant data source identifying unit,
the system having performance indicator analysis information, data source characteristic information, and business process relevance information,
the performance indicator analysis information having, for each performance indicator (KPI), a primary data source condition corresponding to the performance indicator (KPI),
the data source characteristic information having, for each data source, business process identification information which is identification information of a business process corresponding to the data source,
the business process relevance information having business process relevance for each pair of the business processes, wherein
the relevant data source identifying unit is configured to:
identify the primary data source condition on the basis of performance indicator identification information which is identification information of a received performance indicator (KPI) and the performance indicator analysis information;
identify primary data source corresponding business process identification information, which is identification information of a business process corresponding to a primary data source, on the basis of the identified primary data source condition and the data source characteristic information;
determine, for each of the business process identification information, the business process relevance between the business process identification information and the primary data source corresponding business process identification information on the basis of the identified primary data source corresponding business process identification information and the business process relevance information;
determine, for each data source identification information which is identification information of the data source, an importance score for the data source for the received performance indicator (KPI) on the basis of the business process relevance determined for each of the business process identification information and the data source characteristic information; and
identify a relevant data source which is the data source related to the received performance indicator (KPI) on the basis of the importance score determined for each of the data source identification information.

2. The system according to claim 1, wherein
when determining, for each of the data source identification information, an importance score for the data source for the received performance indicator (KPI) on the basis of the process relevance determined for each of the business process identification information and the data source characteristic information, the relevant data source identifying unit further determines the importance score also on the basis of an update frequency for each of the data sources.

3. The system according to claim 1, wherein,
when determining, for each of the data source identification information, an importance score for the data source for the received performance indicator (KPI) on the basis of the process relevance determined for each of the business process identification information and the data source characteristic information, the relevant data source identifying unit further determines the importance score also on the basis of a reference frequency for each of the data sources.

4. The system according to claim 1, wherein
the relevant data source identifying unit is configured to:
identify primary data source identification information, which is identification information of the primary data source, from among the data source identification information managed by the data source characteristic information, on the basis of the identified primary data source condition and the data source characteristic information; and
identify the primary data source corresponding business process identification information on the basis of the identified primary data source identification information and the data source characteristic information,
the number of primary data source conditions identified on the basis of the received performance indicator identification information and the performance indicator analysis information is one or more,
the number of pieces of the primary data source identification information identified from among the data source identification information managed by the data source characteristic information on the basis of one of the primary data source conditions and the data source characteristic information is one or more, and
the number of pieces of the primary data source corresponding business process identification information identified on the basis of one piece of the primary data source identification information and the data source characteristic information is one or more.

5. The system according to claim 1, further comprising a business process relevance updating unit configured to update the business process relevance information on the basis of data access log information, the data access log information including one or more records each indicating an access history by each of one or more access sources to each of one or more data sources, wherein
the business process relevance updating unit is configured to:
distribute each of the records included in the data access log information into one of divided logs on the basis of the access source in the access history indicated by the record and a time period to which a timestamp in the access history indicated by the record belongs;
identify, in each of the divided logs, the business processes corresponding to the data sources accessed by the same access source during the same time period;
count, for each pair of the business processes, the number of the divided logs in which both of the business processes included in the pair are the business processes corresponding to the data sources accessed by the same access source during the same time period, to obtain a count value;
determine the business process relevance for the pair of the business processes on the basis of the count value for the pair of the business processes; and
update the business process relevance information on the basis of the business process relevance determined for each pair of the business processes.

6. The system according to claim 5, wherein
the access source is a data analyst operation system operated by a data analyst, or a data analysis system that accesses the data source in a manner involving relatively less manual intervention than the data analyst operation system, and
in distributing each of the records included in the data access log information into one of divided logs on the basis of the access source in an access history indicated by the record and a time period to which a timestamp in the access history indicated by the record belongs, the business process relevance updating unit sets, for the time period corresponding to one of the divided logs, a shorter duration when the access source is the data analysis system than a duration when the access source is the data analyst operation system.

7. The system according to claim 1, further comprising a performance indicator identification information receiving unit and a relevant data source related information display control unit, wherein
the performance indicator identification information receiving unit is configured to receive the performance indicator identification information via a data source identification graphical user interface, and
the relevant data source related information display control unit is configured to perform, via the data source identification graphical user interface, control to display relevant data source related information which is related information of the relevant data source identified by the relevant data source identifying unit.

8. The system according to claim 7, wherein
the data source identification graphical user interface is a form input type graphical user interface or a chat type graphical user interface.

9. The system according to claim 1, further comprising a primary data source condition updating unit and a primary data source condition version management table, wherein
the primary data source condition updating unit is configured to:
select one or more pieces of the data source identification information on the basis of the importance score determined for each of the data source identification information;
generate one or more new primary data source conditions on the basis of the selected data source identification information;
set the generated one or more primary data source conditions in a record corresponding to the performance indicator identification information received by the relevant data source identifying unit in the performance indicator analysis information; and
register, in the primary data source condition version management table, a new record including the performance indicator identification information received by the relevant data source identifying unit and the generated one or more primary data source conditions.

10. The system according to claim 1, further comprising a performance indicator analysis information setting receiving unit, wherein
the performance indicator analysis information setting receiving unit is configured to receive, via a performance indicator analysis information setting graphical user interface, the performance indicator identification information and one or more of the primary data source conditions, and sets a record such that the record including the performance indicator identification information and the one or more primary data source conditions received exists in the performance indicator analysis information.

11. The system according to claim 1, further comprising a business process registration receiving unit and business process list information, wherein
the business process registration receiving unit is configured to receive the business process identification information via a business process registration graphical user interface, and registers a record including the received business process identification information in the business process list information.

12. The system according to claim 1, further comprising a data source-business process relationship registration receiving unit, wherein
the data source-business process relationship registration receiving unit is configured to:
receive the data source identification information and the business process identification information via a data source business-process relationship registration graphical user interface; and
set a record such that the record including the data source identification information and the business process identification information received exists in the performance indicator analysis information.

13. The system according to claim 1, further comprising one or more processors and a memory hierarchy, wherein
the memory hierarchy has the performance indicator analysis information, the data source characteristic information, and the business process relevance information, and
at least one of the processors executes a program corresponding to the relevant data source identifying unit to realize the relevant data source identifying unit.

14. A method executed by a system, the method comprising steps of:
identifying a primary data source condition on the basis of performance indicator identification information, which is identification information of a received performance indicator (KPI) and performance indicator analysis information having the primary data source condition corresponding to the performance indicator (KPI) for each performance indicator (KPI);
identifying primary data source corresponding business process identification information, which is identification information of a business process corresponding to a primary data source, on the basis of the identified primary data source condition and data source characteristic information having, for each data source, business process identification information which is identification information of a business process corresponding to the data source;
determining business process relevance between each of the business process identification information and the primary data source corresponding business process identification information, on the basis of the identified primary data source corresponding business process identification information and business process relevance information having business process relevance for each pair of the business processes;
determining, for each data source identification information which is identification information of the data source, an importance score for the data source for the received performance indicator (KPI), on the basis of the business process relevance determined for each of the business process identification information and the data source characteristic information; and
identifying, on the basis of the importance score determined for each of the data source identification information, a relevant data source which is the data source related to the received performance indicator (KPI).

15. A recording medium containing a program, the program that causes a system to execute the steps of:
identifying a primary data source condition on the basis of performance indicator identification information, which is identification information of a received performance indicator (KPI) and performance indicator analysis information having the primary data source condition corresponding to the performance indicator (KPI) for each performance indicator (KPI);
identifying primary data source corresponding business process identification information, which is identification information of a business process corresponding to a primary data source, on the basis of the identified primary data source condition and data source characteristic information having, for each data source, business process identification information which is identification information of a business process corresponding to the data source;
determining business process relevance between each of the business process identification information and the primary data source corresponding business process identification information, on the basis of the identified primary data source corresponding business process identification information and business process relevance information having business process relevance for each pair of the business processes;
determining, for each data source identification information which is identification information of the data source, an importance score for the data source for the received performance indicator (KPI), on the basis of the business process relevance determined for each of the business process identification information and the data source characteristic information; and
identifying, on the basis of the importance score determined for each of the data source identification information, a relevant data source which is the data source related to the received performance indicator (KPI).
